(19) United States
(12) Patent Application Publication
(10) Pub. No.: US 2011/0035700 A1
(43) Pub. Date: Feb. 10, 2011

(54) Multi-Operation User Interface Tool

(76) Inventors: Brian Meaney, San Jose, CA (US); Colleen Pendergast, Livermore, CA (US); Dave Cerf, San Francisco, CA (US)

Correspondence Address: ADELI & TOLLEN, LLP, 11940 San Vicente Blvd., Suite 100, LOS ANGELES, CA, 90049, US

(21) Appl. No.: 12/536,482

(22) Filed: Aug. 5, 2009

(51) Int. Cl. G06F 3/048; G06F 3/041

(52) U.S. Cl. 715/784; 715/862; 715/856; 345/173

(57) ABSTRACT

Some embodiments provide a method for performing operations in a user interface of an application. The method activates a cursor to operate as a multi-operation user-interface (UI) tool. The method performs a first operation with the multi-operation UI tool in response to cursor controller input in a first direction. The method performs a second operation with the multi-operation UI tool in response to cursor controller input in a second direction. At least one of the first and second operations is a non-directional operation.

### FIELD OF THE INVENTION

The present invention relates to performing operations in graphical user interfaces. In particular, the invention provides a multi-operation user interface tool for performing multiple different operations in response to user input in different directions.

### BACKGROUND OF THE INVENTION

A graphical user interface (GUI) for a computer or other electronic device with a processor has a display area for displaying graphical or image data. The graphical or image data occupies a plane that may be larger than the display area. Depending on the relative sizes of the display area and the plane, the display area may display the entire plane, or may display only a portion of the plane.

A computer program provides several operations that can be executed for manipulating how the plane is displayed in a display area. Some such operations allow users navigate the plane by moving the plane in different directions. Other operations allow users to navigate the plane by scaling the plane to display a larger or smaller portion in the display area.

The computer program may provide several GUI controls for navigating the plane. Scroll controls, such as scroll bars along the sides of the display area, allow a user to move the plane horizontally or vertically to expose different portions of the plane. Zoom level controls, such as slider bar or a pull-down menu for selecting among several magnification levels, allow a user to scale the plane.

When navigating the plane, users may desire to move and to scale the plane in successive operations. To do so with GUI controls, a user may scroll a scroll bar to move the plane, and then set a zoom level with a zoom level control to scale the plane. Switching back and forth between different GUI controls often requires the user to open and close different controls, or to go back and forth between two locations in the GUI that are an inconvenient distance from each other. Thus, a need exists to provide the user with a way to perform different navigation operations successively without requiring different GUI controls.

### SUMMARY OF THE INVENTION

For a graphical user interface (GUI) of an application, some embodiments provide a multi-operation tool that performs (i) a first operation in the GUI in response to user input in a first direction and (ii) a second operation in the GUI in response to user input in a second direction. That is, when user input in a first direction (e.g., horizontally) is captured through the GUI, the tool performs a first operation, and when user input in a second direction (e.g., vertically) is captured through the UI, the tool performs a second operation. In some embodiments, the directional user input is received from a position input device such as a mouse, touchpad, trackpad, arrow keys, etc.

The different operations performed by the multi-operation tool can be similar in nature or more varied. For instance, in some embodiments, the multi-operation tool is a navigation tool for navigating content in the GUI. The navigation tool of some embodiments performs a directional navigation operation in response to user input in the first direction and a non-directional navigation operation in response to user input in the second direction. As an example of a directional navigation operation, some embodiments scroll through content (e.g., move through content that is arranged over time in the GUI) in response to first direction input. Examples of non-directional navigation operations of some embodiments include scaling operations (e.g., zooming in or out on the content, modifying a number of graphical objects displayed in a display area, etc.).

In some embodiments the content is a plane of graphical data and the multi-operation tool performs different operations for exploring the plane within a display area of the GUI. The multi-operation tool performs at least two operations in response to user input in different directions in order for the user to move from a first location in the content to a second location. As described above, these different operations for exploring the content can include operations to scale the size of the content within the display area and operations to move the content within the display area.

In some embodiments, the application is a media editing application that gives users the ability to edit, combine, transition, overlay, and piece together different media content in a variety of manners to create a composite media presentation. Examples of such applications include Final Cut Pro® and iMovie®, both sold by Apple Computer, Inc. The GUI of the media-editing application includes a composite display area in which a graphical representation of the composite media presentation is displayed for the user to edit. In the composite display area, graphical representations of media clips are arranged along tracks that span a timeline. The multi-operation navigation tool of some embodiments responds to horizontal input by scrolling through the content in the timeline and responds to vertical input by zooming in or out on the content in the timeline.

### BRIEF DESCRIPTION OF THE DRAWINGS

The novel features of the invention are set forth in the appended claims. However, for purpose of explanation, several embodiments of the invention are set forth in the following figures.

FIG. 1 illustrates a typical graphical user interface (“GUI”) of a media editing application used in creating a composite media presentation based on several media clips.

FIGS. 2-3 illustrate one example of how the navigation tool enables a user to use minimal and fluid interaction to perform the task of locating a target media clip in a timeline for some embodiments of the invention.

FIG. 4 presents several examples of possible implementations of the navigation control for some embodiments of the invention.

FIG. 5 illustrates GUI of an application that provides a filmstrip viewer for displaying a sequence of frames from a video clip for some embodiments of the invention.

FIG. 6 illustrates an example of the navigation tool as applied to navigate a sound waveform for some embodiments of the invention.

FIG. 7 illustrates an example of using the navigation tool to perform a two-dimensional scaling operation on a plane of graphical data in a display area for some embodiments of the invention.

FIG. 8 illustrates an example of the navigation tool as applied to navigate tracks in a media editing application for some embodiments of the invention.

FIG. 9 illustrates an example of the navigation tool as applied to navigate any plane of graphical data on a portable electronic device with a touch screen interface for some embodiments of the invention.

FIG. 10 conceptually illustrates a process of some embodiments performed by a touchscreen device for performing different operations in response to touch input in different directions

FIG. 11 conceptually illustrates an example of a machine-executed process executed by an application for selecting between two navigation operations of a navigation tool based on directional input for some embodiments of the invention.

FIG. 12 conceptually illustrates the software architecture of an application of some embodiments for providing a multi-operation tool.

FIG. 13 conceptually illustrates a state diagram for a multi-operation tool of some embodiments.

FIG. 14 conceptually illustrates a process of some embodiments for defining and storing an application of some embodiments.

FIG. 15 conceptually illustrates a computer system with which some embodiments of the invention are implemented.

### DETAILED DESCRIPTION OF THE INVENTION

In the following description, numerous details are set forth for purpose of explanation. However, one of ordinary skill in the art will realize that the invention may be practiced without the use of these specific details. For instance, many of the examples illustrate a multi-operation tool that responds to input in a first direction by scrolling through graphical content and input in a second direction by scaling the graphical content. One of ordinary skill will realized that other multi-operation tools are possible that perform different operations (including non-navigation operations) in response to directional user input.

For a graphical user-interface (GUI) of an application, some embodiments provide a multi-operation tool that performs (i) a first operation in the GUI in response to user input in a first direction and (ii) a second operation in the GUI in response to user input in a second direction. That is, when user input in a first direction (e.g., horizontally) is captured through the GUI, the tool performs a first operation, and when user input in a second direction (e.g., vertically) is captured through the GUI, the tool performs a second operation. In some embodiments, the directional user input is received from a position input device such as a mouse, touchpad, trackpad, arrow keys, etc.

The different operations performed by the multi-operation tool can be similar in nature or more varied. For instance, in some embodiments, the multi-operation tool is a navigation tool for navigating content in the GUI. The navigation tool of some embodiments performs a directional navigation operation in response to user input in the first direction and a non-directional navigation operation in response to user input in the second direction. As an example of a directional navigation operation, some embodiments scroll through content (e.g., move through content that is arranged over time in the GUI) in response to first direction input. Examples of non-directional navigation operations of some embodiments include scaling operations (e.g., zooming in or out on the content, modifying a number of graphical objects displayed in a display area, etc.).

In some embodiments the content is a plane of graphical data and the multi-operation tool performs different operations for exploring the plane within a display area of the GUI. The multi-operation tool performs at least two operations in response to user input in different directions in order for the user to move from a first location in the content to a second location. As described above, these different operations for exploring the content can include operations to scale the size of the content within the display area and operations to move the content within the display area.

In some embodiments, the application is a media editing application that gives users the ability to edit, combine, transition, overlay, and piece together different media content in a variety of manners to create a composite media presentation. Examples of such applications include Final Cut Pro® and iMovie®, both sold by Apple Computer, Inc. The GUI of the media-editing application includes a composite display area in which a graphical representation of the composite media presentation is displayed for the user to edit. In the composite display area, graphical representations of media clips are arranged along tracks that span a timeline. The multi-operation navigation tool of some embodiments responds to horizontal input by scrolling through the content in the timeline and responds to vertical input by zooming in or out on the content in the timeline.

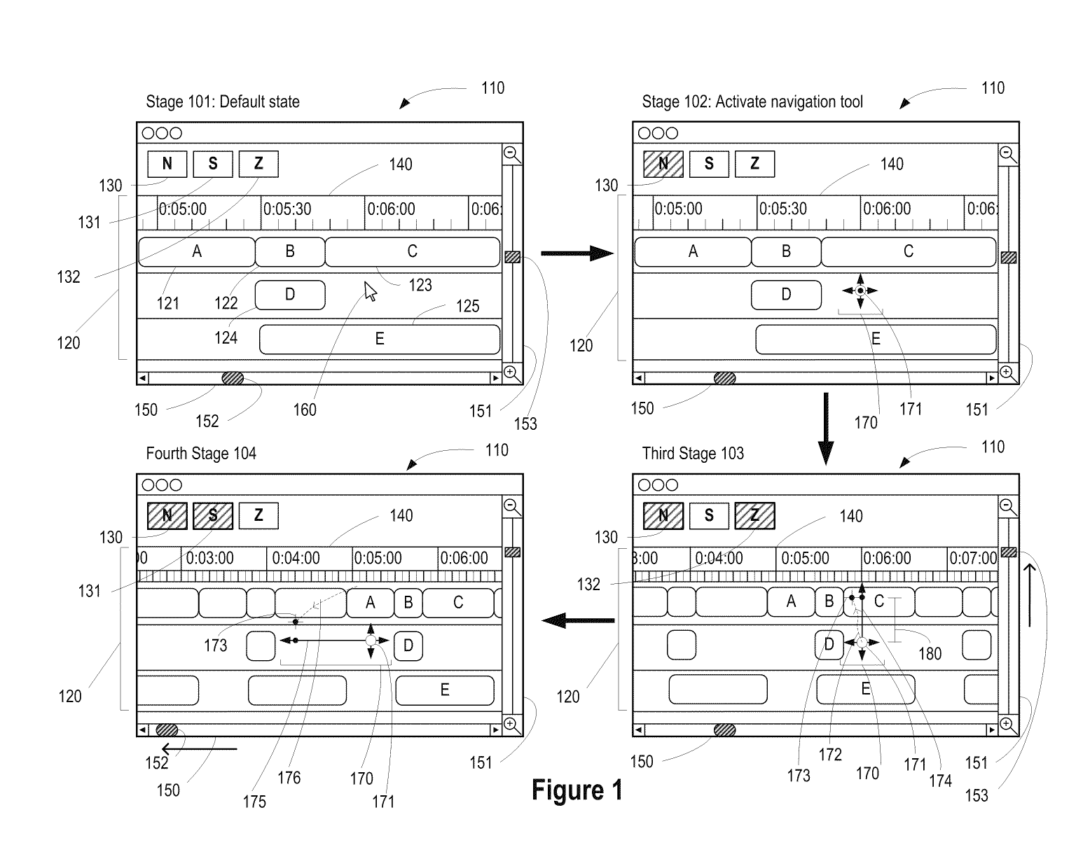

For some embodiments of the invention, FIG. 1 illustrates a graphical user interface (GUI) 110 of a media editing application with such a multi-operation navigation tool for navigating the plane of graphical data in a display area. When the multi-operation navigation tool is activated (e.g., by a user), the GUI 110 includes a user interface control for the navigation tool that allows a user to perform at least two different types of navigation operations. In particular, as described above, the type of navigation operation that is performed by the navigation tool depends on the direction of user input.

FIG. 1 illustrates the GUI 110 at four different stages. At first stage 101, FIG. 1 illustrates the GUI 110 before the navigation tool is activated. In particular, the GUI 110 includes display area 120, media clips 121-125, multi-operation tool UI items 130-132, timeline 140, scroll bar 150, zoom level bar 151, scroll bar control 152, zoom bar control 153, and pointer 160.

Display area 120 displays a portion of a plane of graphical data. As shown in

FIG. 1, the plane is a timeline 140. Media clips 121-125 are arranged within a portion of timeline 140. At first stage 101, the displayed portion of timeline 140 ranges from a time of slightly before 0:05:00 to a time of slightly after 0:06:30.

Timeline 140 can be scrolled or scaled so that different portions of the timeline are displayed in display area 120. The media-editing application provides scroll bar 150 and zoom level bar 151 for performing scrolling and scaling operations on timeline 140, respectively.

For instance, dragging scroll bar control 152 to the left moves timeline 140 to the right. Dragging zoom level bar 151 up scales timeline 140 by reducing the distance between time points. The reduced scale results in compressing the duration represented by timeline 140 into a shorter horizontal span.

The UI items 130-132 are selectable items in some embodiments that a user interacts with (e.g., via a cursor, a touchscreen, etc.) in order to activate the tool or a particular operation of the tool. In some embodiments, however, the UI items (or at least some of the UI items) represent activation states of the multi-operation tool, and the user does not actually interact with the items 130-132 in order to activate the tool or one of its operations. For instance, in some embodiments the tool is activated through a keystroke or combination of keystrokes. When the tool is activated, UI item 130 is modified to indicate this activation. In some embodiments, there is no activation UI item, but the display of cursor 160 changes to indicate the activation of the multi-operation tool. At first stage 101, each of UI items 130-132 is shown in an ‘off’ state, indicating that the multi-operation tool is not activated.

At second stage 102, FIG. 1 illustrates GUI 110 after the navigation tool is activated. In particular, the GUI 110 at second stage 102 illustrates UI item 130 in an ‘on’ state, indicating that the multi-operation navigation tool has been activated. The GUI 110 at second stage 102 also illustrates navigation control 170. In some embodiments, navigation control 170 replaces pointer 160 when the navigation tool is activated. For some embodiments of the invention, activating the navigation tool fixes an origin 171 of navigation control 170 at the location of the pointer 160. When origin 171 is fixed, input from a position input device does not change the position of origin 171. Other embodiments do not fix the origin 171 until the multi-operation navigation tool starts to perform one of its operations.

The navigation tool can be activated by a variety of mechanisms. In some embodiments, a user may interact with the UI item 130 to activate the navigation tool. For instance, the UI item 130 may be implemented as a GUI toggle button that can be clicked by a user to activate the navigation tool. In other embodiments, the tool is not activated through a displayed UI item. Instead, as mentioned above, the tool is activated through a key or button on a physical device, such as on a computer keyboard or other input device. For instance, the activation input may be implemented as any one of the keys of a computer keyboard (e.g., the ‘Q’ key), as a button or scroll wheel of a mouse, or any combination of keys and buttons. In some embodiments, the activation input is implemented through a touchscreen (e.g., a single tap, double tap, or other combination of touch input). In some embodiments, the activation input may be pressed by a user to activate the navigation tool. In some embodiments, the input activates the navigation tool when it is held down, and deactivates the navigation tool when it is released. In some other embodiments, the activation input activates the navigation tool when it is first pressed and released, and deactivates the navigation tool when it is again pressed and released. The navigation tool may also be activated, in some embodiments, when the cursor is moved over a particular area of the GUI.

At third stage 103, FIG. 1 illustrates the GUI 110 at a moment when a scaling operation is in progress. In particular, at this stage, the GUI 110 shows UI items 130 and 132 in an ‘on’ state, indicating that the multi-operation navigation tool is activated and is performing a scaling operation. The GUI 110 additionally displays navigation control 170 with upper arrow 174 extended from origin 171, and zoom bar control 153 which has been moved upward as compared to its position in second stage 102 to reflect the change in scale performed by the navigation tool. FIG. 1 at third stage 103 also illustrates two invisible features, shown in the figure as movement path 172 and target 173, which are not visibly displayed in GUI 110.

At third stage 103, the zoom operation is performed in response to directional input that is received after the navigation tool is activated. Sources of such directional input include a mouse, a trackball, one or more arrow keys on a keyboard, etc. In some embodiments, for one of the multiple operations to be performed, the directional input must be received in combination with other input such as holding a mouse button down (or holding a key different than an activation key, pressing a touchscreen, etc.). Prior to holding the mouse button down, some embodiments allow the user to move the navigation control 170 (and thus origin 171) around the GUI in order to select a location for origin 171. When the user combines the mouse button with directional movement, one of the operations of the multi-operation navigation tool is performed.

In the example, this directional input moves target 173. At third stage 103, the position input moves target 173 away from origin 171 in an upward direction. The path traveled by target 173 is marked by path 172. In some embodiments, target 173 and path 172 are not displayed in GUI 110, but instead are invisibly tracked by the application.

For the example shown in FIG. 1 at third stage 103, the difference in Y-axis positions between target 173 and origin 171 is shown as difference 180. For some embodiments, such as for the example shown in FIG. 1, the application extends an arrow 174 of the navigation control 170 to show difference 180. In some other embodiments, the arrows of navigation control 170 do not change during a navigation operation. Although the movement includes a much smaller leftward horizontal component, some embodiments use whichever component is larger as the direction of input.

In response to detecting the directional input, the navigation tool performs a scaling operation, as indicated by the UI item 132 appearing in an ‘on’ state. In this example, at third stage 103, the scale of the timeline is at a moment when it has been reduced such that the displayed portion of timeline 140 ranges from a time of approximately 0:03:18 to 0:07:36 in display area 120. The scaling operation either expands or reduces the scale of timeline 140 by a ‘zoom in’ operation or ‘zoom out’ operation, respectively. For some embodiments, when target 173 is moved above origin 171, the ‘zoom out’ operation is performed. Conversely, when target 173 is moved below origin 171, the ‘zoom in’ operation is performed. Other embodiments reverse the correlation of the vertical directions with zooming out or in.

Once the tool begins performing the zoom operation, it continues to do so until the zoom operation is deactivated, or until a maximum or a minimum zoom level is reached. In some embodiments, zoom operation is deactivated when either operation deactivation input (e.g., releasing a mouse button) or horizontal direction input (scroll operation input) is received.

In some embodiments, the length of the difference in Y-axis positions determines the rate at which the scale is reduced or expanded. A longer difference results in a faster rate at which the scale is reduced, and vice versa. For instance, in the example at third stage 103, when the difference in Y-axis positions is difference 180, the zoom tool reduces the scale of timeline 140 at a rate of 5 percent magnification per second. In some embodiments, the speed of the user movement that produces the directional input determines the rate at which the scale is expanded or reduced.

In some embodiments, the navigation tool centers the scaling operation on the position of the fixed origin 171 of the navigation control 170. In the example illustrated in FIG. 1, when the zoom tool is activated, origin 171 of the navigation control is located below timecode 0:06:00. When the scale is reduced, the zoom tool fixes timecode 0:06:00 in one position in display area 120. Accordingly, at the moment shown in third stage 103 when a scaling operation is being performed, origin 171 remains below timecode 0:06:00.

The navigation tool allows a user to perform a scrolling operation directly before or after a scaling operation, as demonstrated at fourth stage 104 of FIG. 1. At fourth stage 104, FIG. 1 illustrates GUI 110 at a moment when a scrolling operation is in progress. In particular, at this stage, the GUI 110 includes UI items 130 and 131 in an ‘on’ state, indicating that the navigation tool is still activated and is performing a scrolling operation. The GUI 110 additionally shows navigation control 170 with left arrow 175 extended from origin 171, and scroll bar control 152 which has been moved leftward as compared to its position in the previous stages. FIG. 1 at fourth stage 104 also illustrates invisible features movement path 176 and target 173, which are not visibly displayed in GUI 110.

In the example shown in FIG. 1 at fourth stage 104, the scaling operation stops and scrolling operation starts when input is received in the direction of movement path 176. This input has a larger horizontal component than it does vertical component, and thus the scrolling operation is performed by the multi-operation navigation tool. In some embodiments, the difference between the target's horizontal position at stage 103 and 104 determines the scroll rate for the scrolling operation. In some embodiments, the application extends left arrow 175 to show the difference in X-axis positions (and thus the scroll rate). In some other embodiments, the arrow remains fixed and retracted.

As shown in FIG. 1 at fourth stage 104, the timeline is at a moment when it is being shifted rightward by a ‘scroll left’ operation. At the moment of fourth stage 104, the displayed portion of timeline 140 ranges from a time of approximately 00:02:28 to 00:06:45. Similar to the zoom operation, the scroll tool either scrolls right or scrolls left depending on whether the most recently received directional input is rightwards or leftwards.

The scroll operation continues until it is deactivated, or until one of the ends of timeline 140 is reached. Like for the scaling operation described above, in some embodiments, the scroll operation is performed when predominantly horizontal input is received, and the multi-operation navigation tool stops performing the scroll operation when either new vertically directed input is received (which causes the performance of the scaling operation), or deactivation input is received (e.g., release of a mouse button).

The length of the difference in X-axis positions determines the rate at which timeline 140 is shifted by the scroll tool in some embodiments. A longer difference results in a faster rate at which timeline 140 is shifted, and vice versa.

The example illustrated in FIG. 1 demonstrates a multi-operation navigation tool that allows a user to perform at least two different types of navigation operations on a timeline of a media editing application by interacting with one user interface control that can be positioned anywhere in the timeline. However, one of ordinary skill will realize that the above-described techniques are used in other embodiments on different types of graphical content, such as sound waveforms, maps, file browser, web page, photos or other prepared graphics, media object browser, textual documents, spreadsheet documents, and any other graphical content on a plane that is displayed in a display area of a graphical user interface. Furthermore, the above-described techniques are used in other embodiments to perform navigation operations other than scrolling and scaling. For example, the navigation tool may be used to select a number of graphical objects to display in a display area.

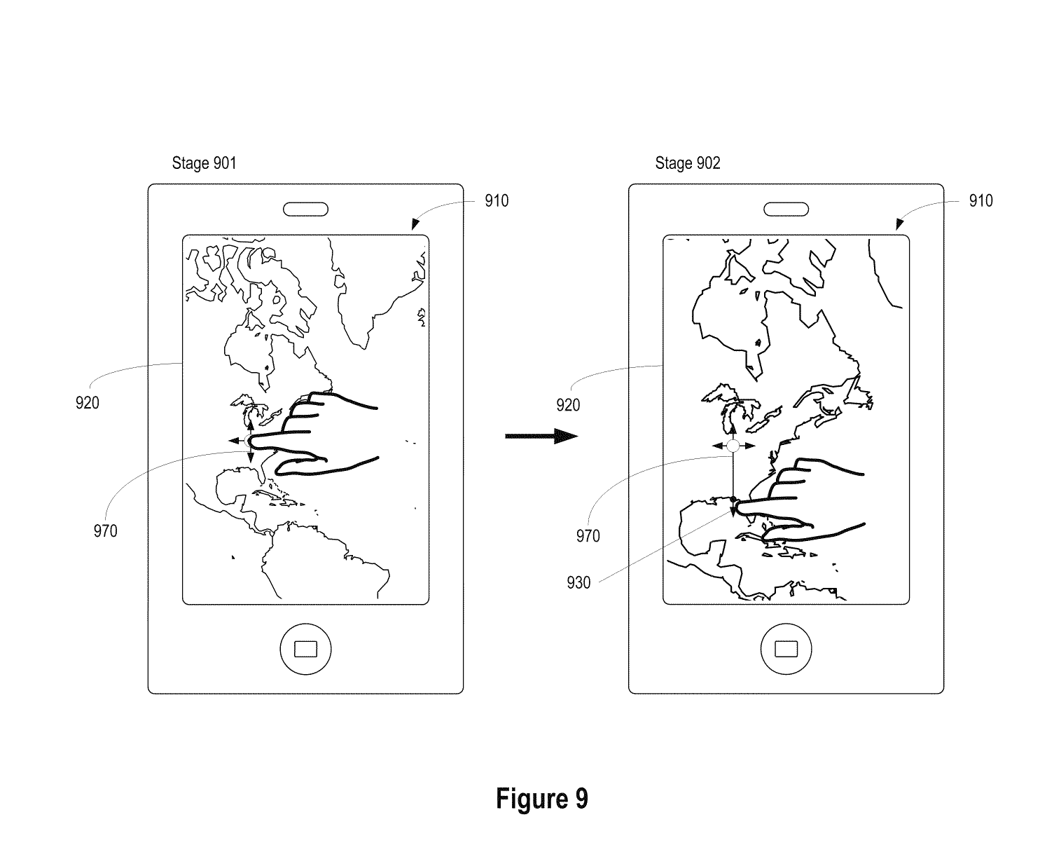

The example illustrated in FIG. 1 shows one possible implementation of a navigation tool that allows a user to perform at least two different types of navigation operations in response to a position of a target in relation to an origin of a graphical user interface control. One of ordinary skill will realize that many other possible implementations exist. For instance, in some embodiments, the user interface control shown in the GUI does not appear as two double-headed arrows intersecting perpendicularly. Instead, the user interface control may appear as any combination of shapes that provides appropriate feedback for the features of the invention. For some embodiments, such as on a touch-screen device, the navigation tool responds to position input from the touch control on a touch screen without providing any visible user interface control as feedback for the position input. In such embodiments, the navigation tool may be instructed to respond to a combination of finger contacts with the touch screen (e.g., taps, swipes, etc.) that correspond to the various user interactions described above (e.g., fixing an origin, moving a target, etc.). However, a visible navigation control may be used with a touch screen interface, as will be described below by reference to FIG. 9.

A navigation tool that allows a user to perform at least two different types of navigation operations on a plane of graphical data by interacting with one user interface control provides the advantage of speed and convenience over a prior approach of having to activate a separate tool for each navigation operation. Additionally, because the navigation tool provides for continuous scaling and scrolling operations upon activation, a user may scale and scroll through all portions of the plane with position input that is minimal and fluid, as compared to prior approaches.

Several more detailed embodiments of the invention are described in the sections below. In many of the examples below, the detailed embodiments are described by reference to a position input device that is implemented as a mouse. However, one of ordinary skill in the art will realize that features of the invention can be used with other position input devices (e.g., mouse, touchpad, trackball, joystick, arrow control, directional pad, touch control, etc.). Section I describes some embodiments of the invention that provide a navigation tool that allows a user to perform at least two different types of navigation operations on a plane of graphical data by interacting with one user interface control. Section II describes examples of conceptual machine-executed processes of the navigation tool for some embodiments of the invention. Section III describes an example of the software architecture of an application and a state diagram of the described multi-operation tool. Section IV describes a process for defining an application that incorporates the multi-operation navigation tool of some embodiments. Finally, Section V describes a computer system and components with which some embodiments of the invention are implemented.

### I. Multi-Operation Navigation Tool

As discussed above, several embodiments provide a navigation tool that allows a user to perform at least two different types of navigation operations on a plane of graphical data by interacting with one user interface control that can be positioned anywhere in the display area.

The navigation tool of some embodiments performs different types of navigation operations based on a direction of input from a position input device (e.g., a mouse, touchpad, trackpad, arrow keys, etc.). The following discussion will describe in more detail some embodiments of the navigation tool.

### A. Using the Navigation Tool to Perform a Locating Task

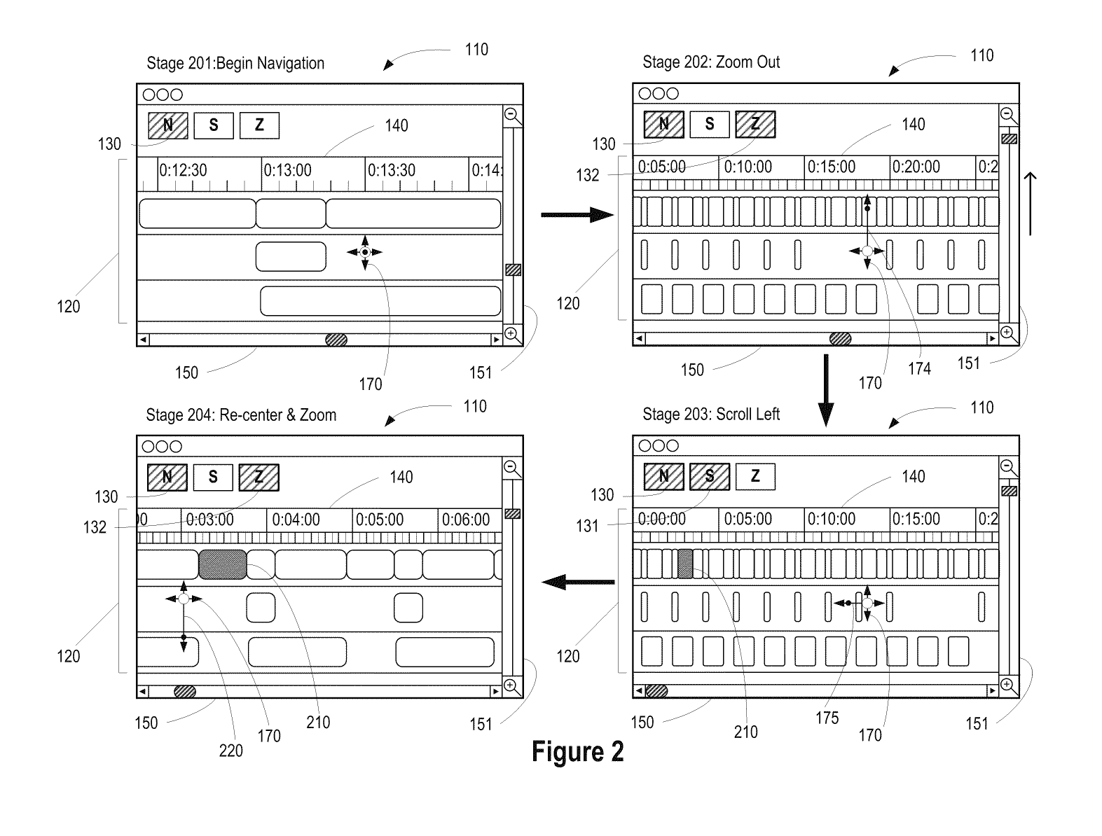

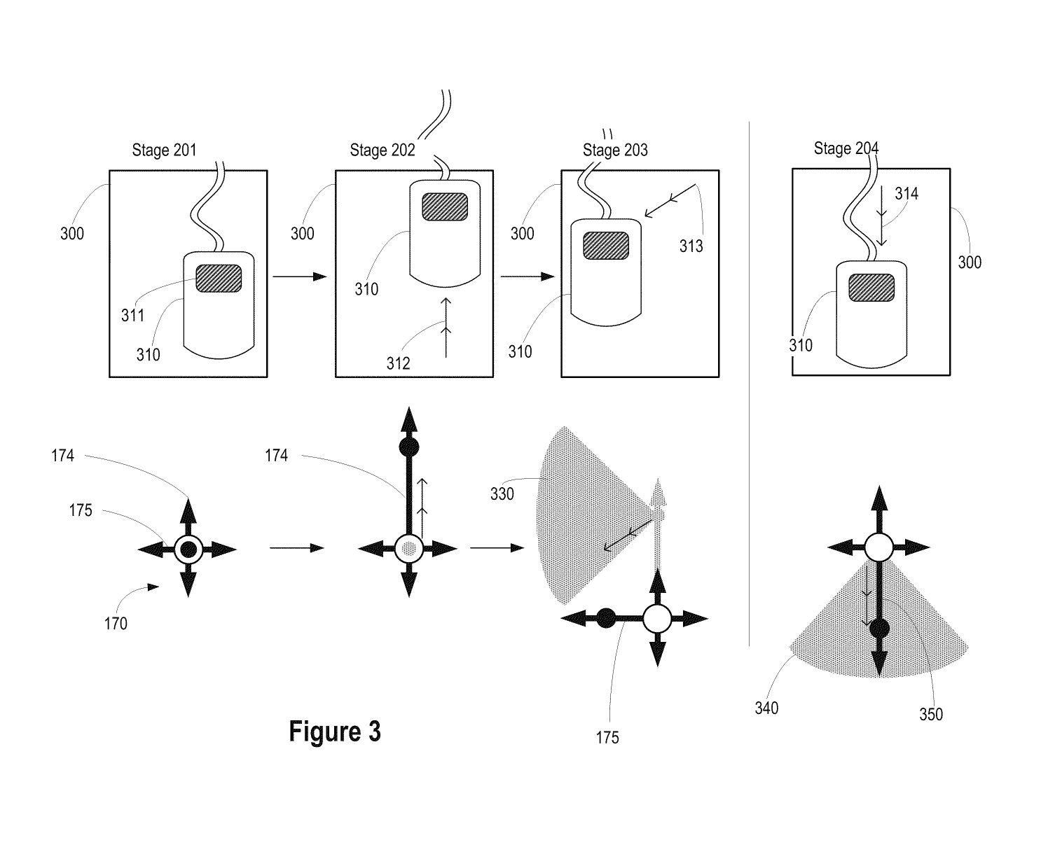

When editing a media project (e.g., a movie) in a media editing application, it is often desirable to quickly search and locate a media clip in a composite display area. Such search and locate tasks require that the user be able to view the timeline both in high magnification for viewing more detail, and low magnification for viewing a general layout of the media clips along the timeline. FIGS. 2-3 illustrate one example of how the navigation tool enables a user to use minimal and fluid interaction to perform the task of locating a target media clip in a composite display area for some embodiments of the invention.

FIG. 2 illustrates four stages of a user's interaction with GUI 110 to perform the locating task for some embodiments of the invention. At stage 201, the user begins the navigation. As shown, the navigation tool is activated, as indicated by the shading of UI item 130 and the display of navigation control 170. The user has moved the navigation control to a particular location on the timeline under timecode 0:13:30, and has sent a command (e.g., click-down on a mouse button) to the navigation tool to fix the origin at the particular location.

At stage 202, the user uses the multi-operation navigation tool to reduce the scale of the timeline (“zooms out”) in order to expose a longer range of the timeline in the display area 120. The user activates the zoom operation by interacting with the navigation control using the techniques described above with reference to FIG. 1, and as will be described below with reference to FIG. 3. As shown in the example illustrated in FIG. 2, the upper arrow 174 is extended to indicate that a ‘zoom out’ operation is being executed to reduce the scale of the timeline. The length of upper arrow 174 indicates the rate of scaling. At stage 202, the scale of timeline is reduced such that the range of time shown in the display area is increased tenfold, from a time of about 2 minutes to a time of over 20 minutes.

At stage 203, the user uses the navigation tool to scroll leftward in order to shift the timeline to the right to search for and locate the desired media clip 210. The user activates the scroll operation by interacting with the navigation control using the techniques described above with reference to FIG. 1, and as will be described below with reference to FIG. 3. As shown in FIG. 2, the left arrow 175 is extended to indicate that a ‘scroll left’ operation is being executed, and to indicate the rate of the scrolling. In this example, the user has scrolled to near the beginning of the timeline, and has identified desired media clip 210.

At stage 204, the user uses the navigation tool to increase the scale around the desired media clip 210 (e.g., to perform an edit on the clip). From stage 203, the user first sends a command to detach the origin (e.g., releasing a mouse button). With the origin detached, the navigation tool of some embodiments allows the user to reposition the navigation control closer to the left edge of display area 120. The user then fixes the origin of navigation control 170 at the new location (e.g., by pressing down on a mouse button again), and activates the zoom operation by interacting with the navigation control using the techniques described above with reference to FIG. 1. As shown in FIG. 2, the lower arrow 220 is extended to indicate that a ‘zoom in’ operation is being executed, and to indicate the rate of scaling. At stage 204, the scale of timeline is increased such that the range of time shown in the display area is decreased from a time of over 20 minutes to a time of about 5 minutes.

By reference to FIG. 3, the following describes an example of a user's interaction with a mouse to perform stages 201-204 for some embodiments of the invention. As previously mentioned, the multi-operation navigation tool allows the user to perform the search and locate task described with reference to FIG. 2 with minimal and fluid position input from a position input device.

In the example illustrated in FIG. 3, the operations are described with respect to a computer mouse 310 that is moved by a user on a mousepad 300. However, one of ordinary skill in the art would understand that the operations may be performed using analogous movements without a mousepad or using another position input device such as a touchpad, trackpad, graphics tablet, touchscreen, etc. For instance, a user pressing a mouse button down causes a click event to be recognized by the application or the operating system. One of ordinary skill will recognize that such a click event need not come from a mouse, but can be the result of finger contact with a touchscreen or a touchpad, etc. Similarly, operations that result from a mouse button being held down may also be the result of any sort of click-and-hold event (a finger being held on a touchscreen, etc.).

At stage 201, the user clicks and holds down mouse button 311 of mouse 310 to fix the origin of the navigation control 170 (a click-and-hold event). In some other embodiments, instead of holding down the mouse button 311 for the duration of the navigation operation, the mouse button 311 is clicked and released to fix the origin (a click event), and clicked and released again to detach the origin (a second click event). Other embodiments combine keyboard input to fix the origin with directional input from a mouse or similar input device.

At stage 202, while mouse button 311 is down, the user moves the mouse 310 in a forward direction on mousepad 300, as indicated by direction arrows 312. The upward direction of the movement directs the navigation tool to activate and perform the ‘zoom out’ operation of stage 202.

While the direction arrows 312 appear to indicate that the movement is in a straight line, the actual direction vector for the movement need only be within a threshold of vertical to cause the navigation tool to perform the zoom out operation of stage 202. The direction vector is calculated based on the change in position over time of the mouse. As actual mouse movements will most likely not be in a true straight line, an average vector is calculated in some embodiments so long as the direction does not deviate by more than a threshold angle. In some embodiments, a direction vector is calculated for each continuous movement that is approximately in the same direction. If the movement suddenly shifts direction (e.g., a user moving the mouse upwards then abruptly moving directly rightwards), a new direction vector will be calculated starting from the time of the direction shift. One of ordinary skill will recognize that the term ‘vector’ is used generically to refer to a measurement of the speed and direction of input movement, and does not refer to any specific type of data structure to store this information.

Once the scaling operation has begun, in some embodiments a user need only hold down the mouse button (or keep a finger on a touchscreen, etc.) in order to continue zooming out. Only if the user releases the mouse button or moves the mouse in a different direction (i.e., downwards to initiate a zoom in operation or horizontally to initiate a scrolling operation) will the zoom out operation end.

At stage 203, when the desired zoom level is reached, the user moves the mouse 310 in a diagonal direction on mousepad 300 to both terminate the performance of the ‘zoom out’ operation and to initiate the performance of a ‘scroll left’ operation by the multi-operation navigation tool. As shown by angular quadrant 330, this movement has a larger horizontal component than vertical component. Accordingly, the horizontal component is measured and used to determine the speed of the scroll left operation.

In some embodiments, the length of the direction vector (and thus, the speed of the scroll or scale operation) is determined by the speed of the mouse movement. Some embodiments use only the larger of the two components (horizontal and vertical) of the movement direction vector to determine an operation. On the other hand, some embodiments break the direction vector into its two components and perform both a scaling operation and a scrolling operation at the same time according to the length of the different components. However, such embodiments tend to require more precision on the part of the user. Some other embodiments have a threshold (e.g., 10 degrees) around the vertical and horizontal axes within which only the component along the nearby axis is used. When the direction vector falls outside these thresholds (i.e., the direction vector is more noticeably diagonal), then both components are used and the navigation tool performs both scaling and scrolling operations at the same time.

Between stages 203 and 204, the user detaches the origin, and repositions the navigation control at the new location. In this example, the user detaches the origin by releasing mouse button 311. Upon detaching the origin, further position input from any position input device repositions the navigation control without activating either of the operations. However, unless deactivation input is received, the multi-operation navigation tool remains active (and thus the navigation control is displayed in the GUI instead of a pointer). The navigation control may be repositioned anywhere within the display area during this period.

At stage 204, after the user detaches the origin and repositions the navigation control at the new location, the user clicks and holds down mouse button 311 to fix the origin of the navigation control near or on the desired media clip 210. Once the origin is fixed, any further position input from the mouse causes one of the multiple navigation operations to be performed. The user next moves the mouse 310 in a downward direction on mousepad 300 to begin the ‘zoom in’ operation at the new location.

FIGS. 2-3 illustrate how a user uses the navigation tool to perform a search and locate task for some embodiments of the invention. By minimal and fluid mouse movements as position input, the user is able to perform both scrolling and scaling in order to complete the search and locate task as described. One of ordinary skill will recognize that numerous other uses for such a multi-operation navigation tool exist, both in a media-editing application and in other applications. Section II.B, below, illustrates some other uses for such a multi-operation navigation tool.

### B. Alternative Implementations of Navigation Tool and Control

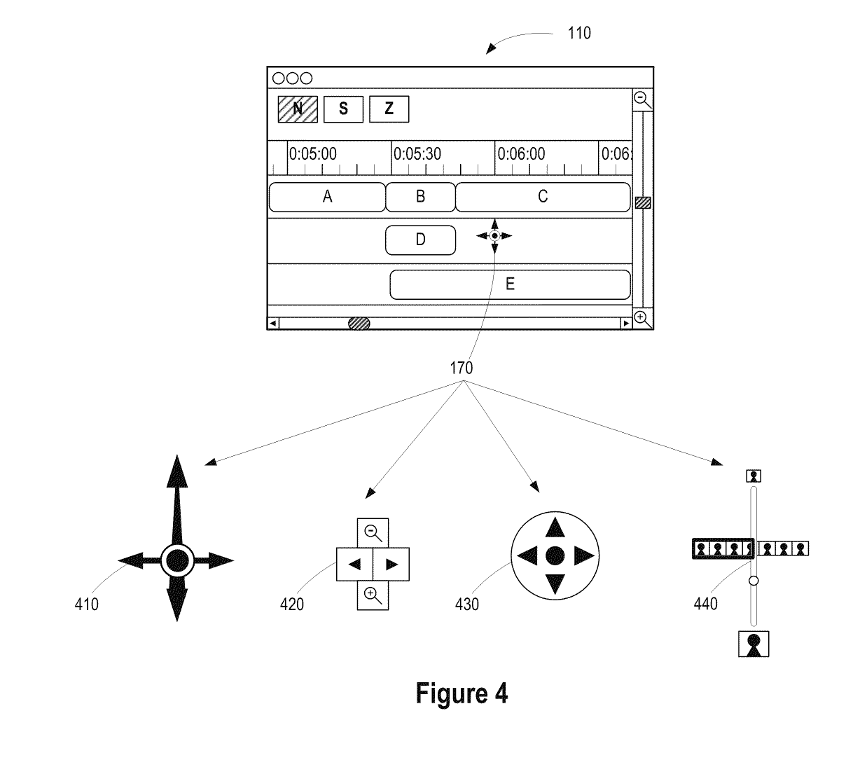

The examples discussed above by reference to FIGS. 1-3 show several possible implementations of the multi-operation navigation tool that allows a user to perform at least two different types of navigation operations in response to user input in different directions. The following discussion presents other implementations of navigation tool for some embodiments of the invention by reference to FIGS. 4-9.

FIG. 4 presents several examples of possible implementations of the navigation control (that is, the graphically displayed item in the UI representing the multi-operation navigation tool) for some embodiments of the invention. Each of controls 410-440 provides at least some of the same possible features and functions previously discussed by reference to FIGS. 1-3. A common theme among the navigation controls is the quaternary nature of the controls, with four portions of the control corresponding to four distinct operations. Each control has two distinct orientations: a horizontal orientation and a vertical orientation. Each horizontal or vertical orientation corresponds to one type of navigation operation (e.g., scaling) in some embodiments. Each end of an orientation is associated with opposite effects of a type of navigation operation (e.g. ‘zoom in’ and ‘zoom out’) in some embodiments. Some embodiments, though, include other numbers of operations—for example, rather than just horizontal and vertical direction input, directional input along the 45 degree diagonals might cause the multi-operation tool to perform a different operation. Furthermore, some embodiments have opposite directions (i.e., either end of a particular orientation) associated with completely different operations. That is, upward directional input might be associated with a first type of operation while downward directional input is associated with a second, different type of operation rather than an opposite of the first type of operation.

Compass navigation control 410 is an example of a navigation control that can be used in some embodiments of the invention. As shown in FIG. 4, it is presented as a pair of double-headed arrows, one of which is vertically-oriented, and the other of which is horizontally-oriented. The two sets of arrows intersect perpendicularly at an origin. The vertically-oriented arrow is tapered to indicate to the user each direction's association with the scaling operation. The upper end is smaller to indicate an association with a scale-reduction, or ‘zoom out,’ operation, while the lower end is larger to indicate an association with a scale-expansion, or ‘zoom in,’ operation.

Pictographic navigation control 420 is another example of a navigation control for some embodiments of the invention. As shown in FIG. 4, pictographic control 420 has four images arranged together in an orthogonal pattern. The left- and right-oriented pictures depict left and right arrows, respectively, to indicate association with the ‘scroll left’ and ‘scroll right’ operations, respectively. The top- and bottom-oriented pictures depict a magnifying glass with a ‘+’ and a ‘−’ symbol shown within to indicate association with the ‘zoom in’ and ‘zoom out’ operations, respectively. The images may change color to indicate activation during execution of the corresponding navigation operation. Pictographic control 420 is an example of a fixed navigation control for some embodiments where no portions of the control extend during any navigation operations.

Circular navigation control 430 is another example of a navigation control of some embodiments. As shown in FIG. 4, circular control 430 is presented as a circle with four small triangles within the circle pointing in orthogonal directions. Like the navigation control 170 described by reference to FIG. 1, circular control 430 has upper and lower triangles that correspond to one navigation operation, and left and right triangles that correspond to the another navigation operation. Circular control 430 is another example of a fixed navigation control for some embodiments in which no portions of the control extend during any navigation operations.

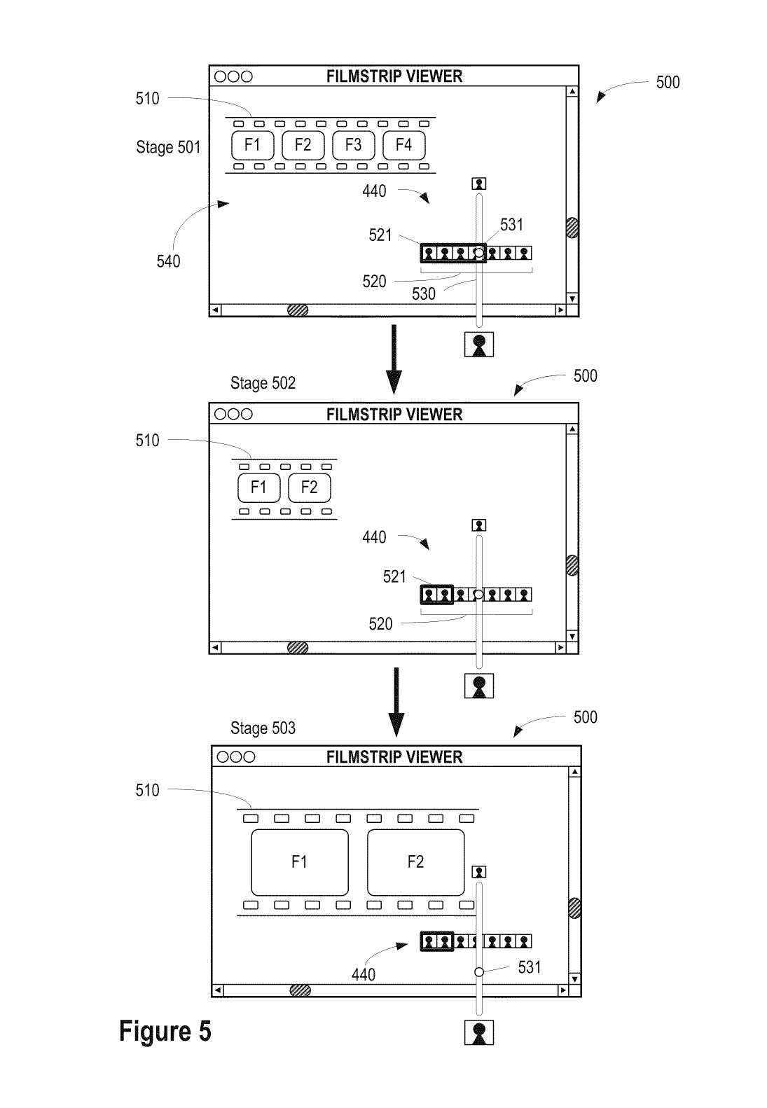

Object navigation control 440 is another example of a navigation control for some embodiments of the invention. As shown in FIG. 4, object control 440 is presented with a horizontal control for specifying a number of graphical objects to display in a display area. The horizontal control is intersected perpendicularly by a vertical control. The vertical control is for adjusting the size of the objects in a display area (and thus the size of the display area, as the number of objects stays constant). The operation of object navigation control 440 for some embodiments will be further described by reference to FIG. 5 below.

While four examples of the navigation control are provided above, one of ordinary skill will realize that controls with a different design may be used in some embodiments. Furthermore, parts of the control may be in a different alignment, or may have a different quantity of parts in different orientations than are presented in examples shown in FIG. 4.

The following discussion describes the operation of object navigation control 440 as discussed above by reference to FIG. 4. FIG. 5 illustrates GUI 500 of an application that provides a filmstrip viewer for displaying a sequence of frames from a video clip for some embodiments. The application also provides a navigation tool for navigating filmstrips in a display area of some embodiments. The navigation tool in some such embodiments includes object navigation control 440 for navigating the filmstrip. FIG. 5 illustrates a user's interaction with GUI 500 in three different stages. At first stage 501, GUI 500 of the filmstrip viewer includes filmstrip 510 and navigation control 440. In this example, at first stage 501, filmstrip 510 displays the first four frames from a media clip. Similar to the example shown in FIG. 4, object control 440 in FIG. 5 includes a horizontal control 520 for selecting a quantity of objects. The horizontal control 520 is intersected perpendicularly by a vertical control 530. The vertical control 530 is for adjusting the size of the objects in a display area.

At stage 501, the user has activated the navigation tool, and object control 440 is visible in display area 540. Horizontal control 520 has a frame 521 that can be manipulated to control the number of frames of filmstrip 510 to display. As shown in stage 501, frame 521 encloses four frames in the horizontal control 520, which corresponds to the four frames shown for filmstrip 510. Vertical control 530 has a knob 531 that can be manipulated to control the size of filmstrip 510.

At stage 502, GUI 500 shows the filmstrip 510 having two frames, and the frame 521 enclosing two frames. For some embodiments, the navigation tool responds to position input in a horizontal orientation to adjust frame 521. In this example, the user entered leftward position input (e.g., moved a mouse to the left, pressed a left key on a directional pad, moved a finger left on a touchscreen, etc.) to reduce the frames of horizontal control 520 that are enclosed by frame 521.

At stage 503, GUI 500 shows the filmstrip 510 enlarged, and the knob 531 shifted downward. For some embodiments, the navigation tool responds to position input in a vertical orientation to adjust knob 531. In this example, the user entered downward position input (e.g., moved a mouse in a downward motion, or pressed a down key on a keyboard) to adjust knob 531, which corresponds to the navigation tool performing an enlarging operation on the filmstrip 510.

The above discussion illustrates a multi-operation tool that responds to input in a first direction to modify the number of graphical objects (in this case, frames) displayed in a display area and input in a second direction to modify the size of graphical objects. A similar multi-operation tool is provided by some embodiments that scrolls through graphical objects in response to input in the first direction and modifies the size of the graphical objects (and thereby the number that can be displayed in a display area) in response to input in the second direction.

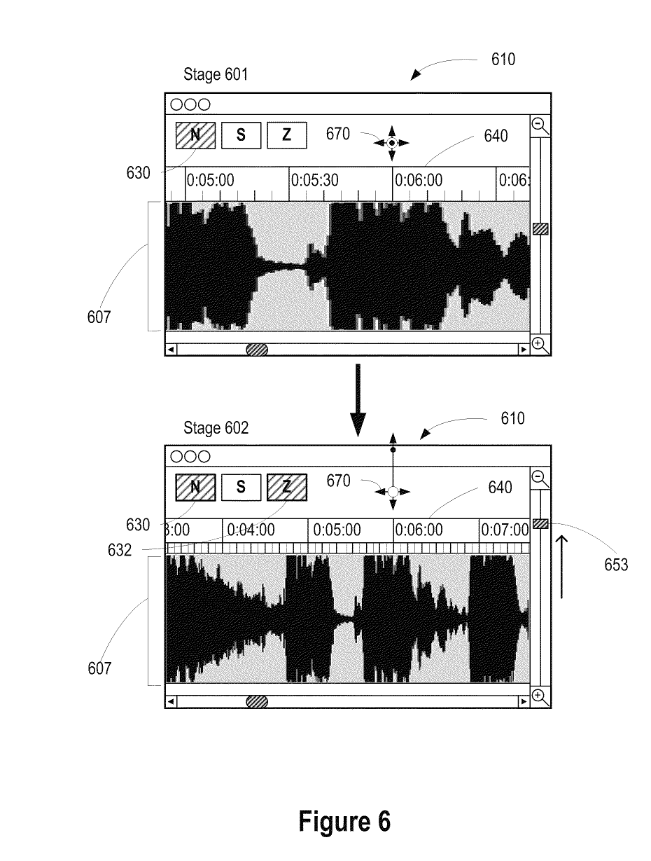

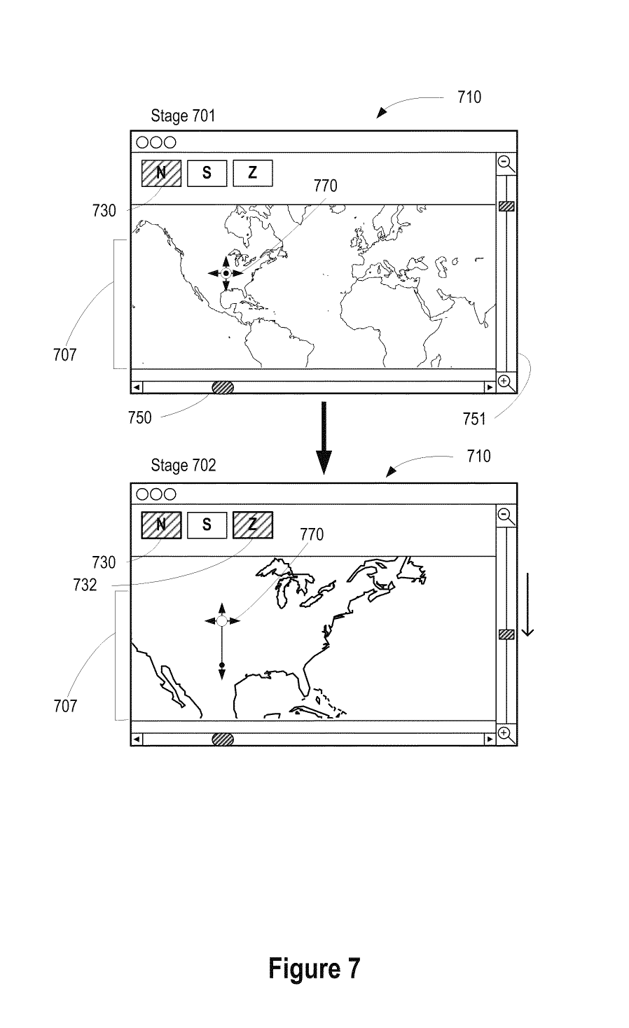

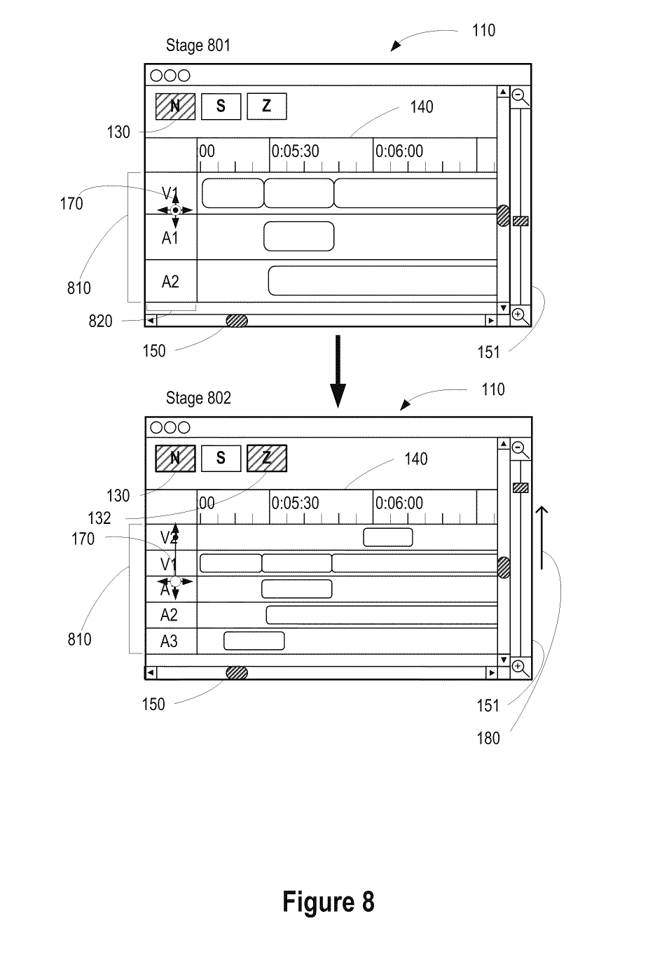

The following discussion describes different implementations of the navigation tool as applied to navigate different types of content by reference to FIGS. 6-9. FIG. 6 illustrates an example of the navigation tool of some embodiments as applied to navigate a sound waveform. FIG. 7 illustrates an example of using the navigation tool to perform a two-dimensional scaling operation on a plane of graphical data in a display area. FIG. 8 illustrates an example of the navigation tool as applied to navigate tracks in a media editing application. FIG. 9 illustrates an example of the navigation tool as applied to navigate a plane of graphical data on a portable electronic device with a touch screen interface. While these examples of different implementations demonstrate use of the multi-operation navigation tool to perform scaling operations, the navigation tool also performs different navigation operations based on other directional input, as described in the preceding examples.

Instead of media clips in a timeline as shown in FIG. 1, FIG. 6 presents a sound waveform 607 in a timeline 640. In particular, FIG. 6 shows two stages of a user's interaction with a GUI 610 to perform a scaling operation on sound waveform 607 using the navigation tool some embodiments. At stage 601, the GUI 610 shows that the navigation tool has been activated, and navigation control 670 has replaced a pointer in the GUI. Similar to the implementation described by reference to FIG. 1, the navigation tool is this example can be activated by a variety of mechanisms (e.g., GUI toggle button, keystroke(s), input from position input device, etc.) The navigation tool activation UI item 630 is shown in an ‘on’ state. At stage 601, the user has fixed the position of the navigation control near the timecode of 0:06:00.

At stage 602, the GUI 610 is at a moment when a scaling operation is in progress.

In particular, at this stage, the GUI 610 shows UI item 632 in an ‘on’ state to indicate performance of the scaling operation. The GUI 610 additionally shows the upper arrow of navigation control 670 extended to indicate that a ‘zoom out’ operation is being performed. Similar to previous examples, a ‘zoom out’ operation is performed when the navigation tool receives upward directional input from a user. The scaling is centered around the origin of the navigation control 670. Accordingly, the point along timeline 640 with timecode 0:06:00 remains fixed at one location during the performing of the ‘zoom out’ operation. The GUI 610 also shows zoom bar control 653 which has been moved upward in response to the ‘zoom out’ operation to reflect a change in scale. At this stage, the sound waveform 607 has been horizontally compressed such that over 4 minutes of waveform data is shown in the display area, as compared to about 1½ minutes of waveform data shown at stage 602.

Other embodiments provide a different multi-operation tool for navigating and otherwise modifying the output of audio. For an application that plays audio (or video) content, some embodiments provide a multi-operation tool that responds to horizontal input to move back or forward in the time of the audio or video content and responds to vertical input to modify the volume of the audio. Some embodiments provide a multi-operation tool that performs similar movement in time for horizontal movement input and modifies a different parameter of audio or video in response to vertical movement input.

The example of FIG. 6 shows one-dimensional (e.g., horizontal) scaling. In contrast, the example of FIG. 7 illustrates using a multi-operation navigation tool to proportionally scale in two dimensions (e.g., horizontal and vertical). In particular, FIG. 7 shows two stages of a user's interaction with a GUI 710 to perform a proportional scaling operation on a map 707 for some embodiments. At stage 701, the GUI 710 shows that the navigation tool has been activated, the navigation control 770 has replaced the pointer in the GUI, and the navigation tool activation item 730 is shown in an ‘on’ state. At stage 701, the user has fixed the position of the navigation tool on the map 707.

At stage 702, the GUI 710 is at a moment when a scaling operation is in progress. In particular, at this stage, the GUI 710 shows UI item 732 in an ‘on’ state to indicate zoom tool activation. The GUI 710 additionally shows the down arrow of navigation control 770 extended to indicate that a ‘zoom in’ operation is being performed. Similar to previous examples, a ‘zoom in’ operation is performed when the navigation tool receives downward directional input from a user. The scaling in this example is also centered around the origin of navigation control 770.

However, unlike previous examples, the zoom tool in the example at stage 702 detects that the pane of graphical data corresponds to a two-dimensional proportional scaling in both the horizontal and the vertical orientations. In two-dimensional proportional scaling, when the ‘zoom in’ operation is performed, both the horizontal and the vertical scales are proportionally expanded. Accordingly, the map 707 appears to be zoomed in proportionally around the origin of the navigation control 770.

In some embodiments with such two-dimensional content, a user will want a multi-operation tool that both scales two-dimensionally, as shown, and scrolls in both directions as well. In some embodiments, the multi-operation tool, when initially activated, responds to input in a first direction by scrolling either vertically, horizontally, or a combination thereof. However, by clicking a second mouse button, pressing a key, or some other similar input, the user can cause the tool to perform a scaling operation in response to movement input in a first one of the directions (either vertically or horizontally), while movement input in the other direction still causes scrolling in that direction. In some such embodiments, a second input (e.g., a double-click of the second mouse button rather than a single click, a different key, etc.) causes movement in the first direction to result in scrolling in that direction while movement in the second direction causes the scaling operation to be performed.

In previous examples, for applications with timelines such as timeline 140 from FIG. 1, the navigation tool was described as implemented for performing the scaling and scrolling operations with respect to a horizontal orientation. In contrast, in the example illustrated in FIG. 8, the navigation tool is used to execute scaling and scrolling operations with respect to a vertical orientation for some embodiments. Specifically, the navigation tool is used to execute scaling to adjust the number of tracks shown in the display area and to scroll through the tracks. FIG. 8 shows two stages of a user's interaction with GUI 110 to perform a vertical scaling operation on a set of tracks 810 for some embodiments.

At stage 801, the GUI 110 shows that the navigation tool has been activated, and the navigation control 170 has replaced the pointer in the GUI. Additionally, the navigation control 170 has been positioned over the track indicators 820, which instructs the navigation tool to apply the navigation operations vertically.

At stage 802, the GUI 110 is at a moment when a scaling operation is in progress to vertically scale the timeline 140. In particular, at this stage, the GUI 110 shows UI item 132 in an ‘on’ state to indicate performance of the scaling operation. The GUI 110 additionally shows the up arrow of navigation control 170 extended to indicate that a ‘zoom out’ operation is being performed. Similar to previous examples, a ‘zoom out’ operation is performed when the navigation tool receives position input that moves a target into a position below the origin of the navigation control that corresponds to a ‘zoom out’ operation. At stage 802, timeline 140 shows the same horizontal scale as compared to stage 801. However, at stage 802, two more tracks are exposed as a result of the ‘zoom out’ operation performed on the tracks in a vertical direction. Similarly, if horizontal input is received, some embodiments perform a scrolling operation to scroll the tracks up or down. Because the operations are performed vertically, some embodiments performs scrolling operations in response to vertical input and scaling operations in response to horizontal input.

Some embodiments provide a context-sensitive multi-operation navigation tool that combines the tool illustrated in FIG. 2 with that illustrated in FIG. 8. Specifically, when the tool is located over the media clips in the composite display area, the multi-operation tool navigates the composite media presentation horizontally as described with respect to FIG. 1 and FIG. 2. However, when the tool is located over the track headers, the tool navigates the tracks as illustrated in FIG. 8.

As previously mentioned, a visible navigation control may be used with a touch screen interface. The example in FIG. 9 illustrates two stages of a user's interaction with a GUI 910 that has a touch screen interface for some embodiments of the invention. In this example, the navigation tool is capable of performing all the functions described in the examples above. However, instead of the navigation tool responding to position input from a remote device, such as a mouse, the navigation tool may be instructed to respond to a combination of finger contacts with the touch screen (e.g., taps, swipes, etc.) that correspond to the various user interactions described above (e.g., fixing an origin, moving a target, etc.).

At stage 901, the GUI 910 shows that the navigation tool has been activated. On a touch screen interface, the navigation tool may be activated by a variety of mechanisms, including by a particular combination of single-finger or multi-finger contact or contacts, by navigating a series of menus, or by interacting with GUI buttons or other UI items in GUI 910. In this example, when the navigation tool is activated, navigation control 970 appears. Using finger contacts, a user drags the navigation control 970 to a desired location, and sends a command to the navigation tool to fix the origin by a combination of contacts, such as a double-tap at the origin.

At stage 902, the GUI 910 is at a moment when a scaling operation is in progress. In particular, the navigation tool has received a command from the touch screen interface to instruct the multi-operation navigation tool to perform a scaling operation to increase the scale of the map 920. The navigation control 970 extends the down arrow in response to the command to provide feedback that the navigation tool is performing the ‘zoom in’ operation. As shown, the command that is received by the navigation tool includes receiving a finger contact event at location of the origin of the navigation tool, maintaining contact while moving down the touch screen interface, and stopping movement while maintaining contact at the point 930 shown at stage 902. With the contact maintained at point 930, or at any point that is below the origin, the zoom tool executes a continuous ‘zoom in’ operation, which is stopped when the user releases contact, or until the maximum zoom level is reached in some embodiments. As in some of the examples described above, the y-axis position difference between the contact point and the origin determines the rate of the scaling operation.

The above techniques described above by reference to FIG. 9 with respect to the ‘zoom in’ operation can be adapted to perform other navigation operations. For instance, in some embodiments, an upward movement from the origin signals a ‘zoom out’ operation. Similar to the non-touch-screen examples, movements in the horizontal orientation may be used to instruct the navigation tool to perform ‘scroll left’ and ‘scroll right’ operations. Furthermore, the orthogonal position input may be combined with other contact combinations to signal other operations. For instance, a double-finger contact in combination with movement in the horizontal orientation may instruct the navigation tool to perform ‘scroll up’ and ‘scroll down’ operations.

While the example shown in FIG. 9 shows the navigation tool with a visible navigation control, one of ordinary skill will realize that many other possible implementations for the navigation tool on a touch screen exist. For instance, the navigation tool responds to position input from the touch control on a touch screen without providing any visible user interface control as feedback for the position input in some embodiments. In some embodiments, the navigation tool responds in the same manner to the finger contacts to perform the navigation operations without any visible navigation control.

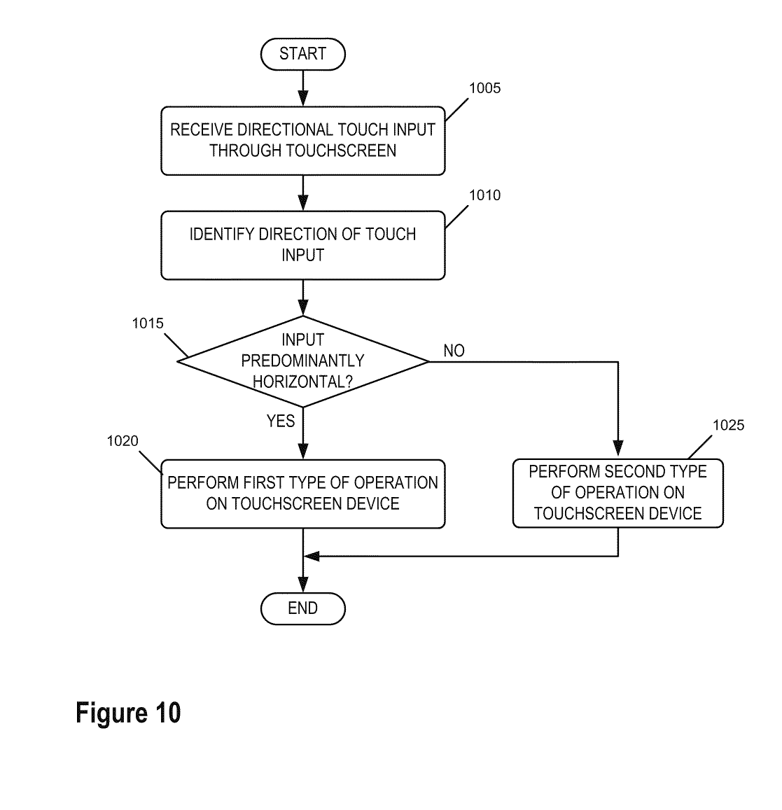

In addition to navigation operations, the multi-operation tool of some embodiments may be used on a touchscreen device to perform all sorts of operations. These operations can include both directional and non-directional navigation operations as well as non-navigation operations. FIG. 10 conceptually illustrates a process 1000 of some embodiments performed by a touchscreen device for performing different operations in response to touch input in different directions.

As shown, process 1000 begins by receiving (at 1005) directional touch input through a touchscreen of the touchscreen device. Touchscreen input includes a user placing a finger on the touchscreen and slowly or quickly moving the finger in a particular direction. In some embodiments, multiple fingers are used at once. Some cases also differentiate between a user leaving the finger on the touchscreen after the movement and the user making a quick swipe with the finger and removing it.

The process identifies (at 1010) a direction of the touch input. In some embodiments, this involves identifying an average direction vector, as the user movement may not be in a perfectly straight line. As described above with respect to mouse or other cursor controller input, some embodiments identify continuous movement within a threshold angular range as one continuous directional input and determine an average direction for the input. This average direction can then be broken down into component vectors (e.g., horizontal and vertical components).

Process 1000 next determines (at 1015) whether the touch input is predominantly horizontal. In some embodiments, the touchscreen device compares the horizontal and vertical direction vectors and determines which is larger. When the input is predominantly horizontal, the process performs (at 1020) a first type of operation on the touchscreen device. The first type of operation is associated with horizontal touch input. When the input is not predominantly horizontal (i.e., is predominantly vertical), the process performs (at 1025) a second type of operation on the touchscreen device that is associated with vertical touch input.

The specific operations of the process may not be performed in the exact order described. The specific operations may not be performed as one continuous series of operations. Different specific operations may be performed in different embodiments. Also, the process could be implemented using several sub-processes, or as part of a larger macro-process.

Furthermore, variations on this process are possible as well. For instance, some embodiments will have four different types of operations—one for each of left, right, up, and down touchscreen interactions. Also, some embodiments will respond to diagonal input that is far enough from the horizontal and vertical axes by performing a combination operation (e.g., scrolling and scaling at the same time). Some embodiments do not perform a decision operation as illustrated at operation 1015, but instead identify the direction of input and associate that direction to a particular operation type.

### II. Process for Performing at Least Two Types of Navigation Operations Using a Navigation Tool

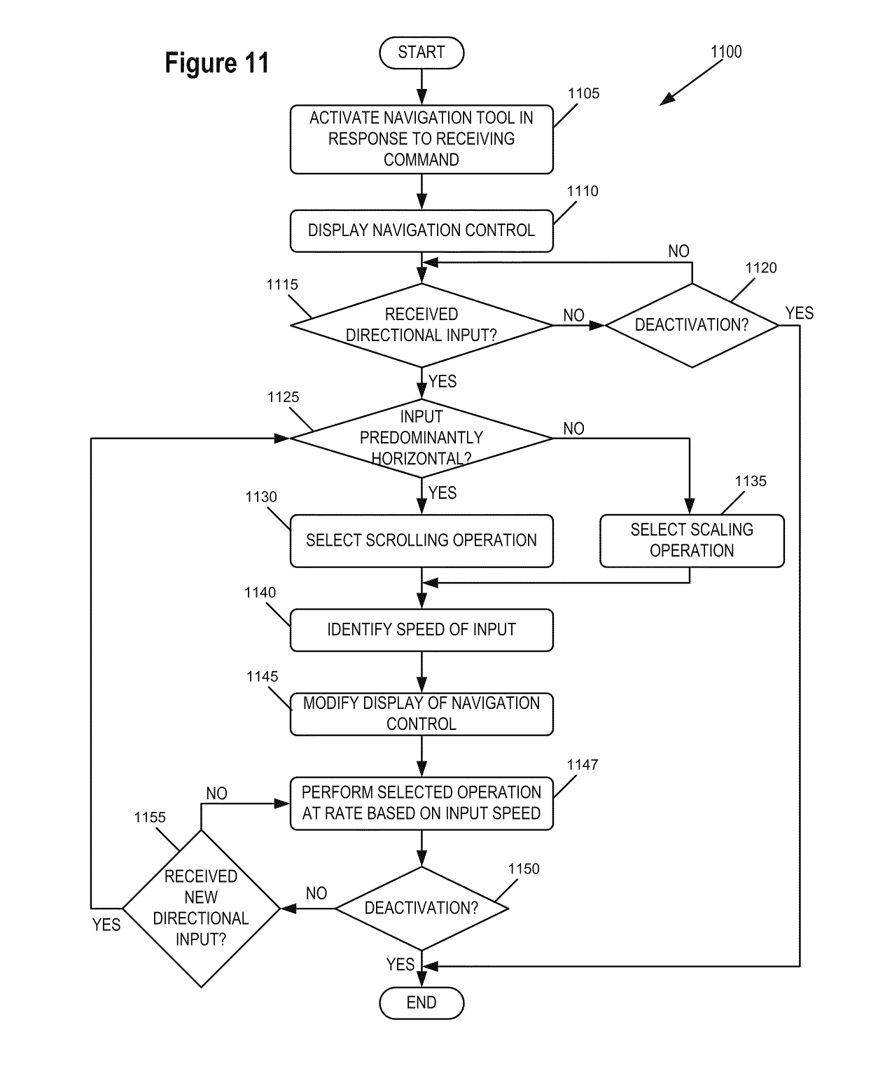

FIG. 11 conceptually illustrates an example of a machine-executed process of some embodiments for performing at least two types of navigation operations using a multi-operation navigation tool. The specific operations of the process may not be performed in the exact order described. The specific operations may not be performed as one continuous series of operations. Different specific operations may be performed in different embodiments. Furthermore, the process could be implemented using several sub-processes, or as part of a larger macro-process.

For some embodiments of the invention, FIG. 11 conceptually illustrates an example of a machine-executed process executed by an application for selecting between two navigation operations of a navigation tool based on directional input. The process 1100 begins by activating (at 1105) a navigation tool in response to receiving an activation command. The activation command may be received by the application through a variety of user interactions. For instance, the application may receive the command as a click-event from a position input device when a pointer is positioned over a UI button in the GUI of the application. The application may also receive the command from a key or button on a physical device, such on a computer keyboard or other input device. For instance, any one of the keys of a computer keyboard (e.g., the ‘Q’ key), any button of a position input device (e.g., mouse button, mouse scroll wheel, trackpad tap combination, joystick button, etc., or any combination of clicks, keys or buttons, may be interpreted by the application program as an activation command.

The process displays (at 1110) a navigation control (i.e., the representation of the tool in the user interface). The navigation control can be positioned by the user anywhere within the display area being navigated. The navigation control may take the form of any of the navigation controls described above by reference to FIGS. 1-9, or any other representation of the multi-operation navigation tool. In some embodiments of the invention, however, the process does not display a navigation control. Instead, the process performs the operations detailed below without displaying any navigation control in the GUI.

Process 1100 then determines (at 1115) whether any directional input has been received. In some embodiments, user input only qualifies as directional input if the directional movement is combined with some other form of input as well, such as holding down a mouse button. Other embodiments respond to any directional user input (e.g., moving a mouse, moving a finger along a touchscreen, etc.). When no directional input is received, the process determines (at 1120) whether a deactivation command has been received. In some embodiments, the deactivation command is the same as the activation command (e.g., a keystroke or combination of keystrokes). In some embodiments, movement of the navigation control to a particular location (e.g., off the timeline) can also deactivate the multi-operation navigation tool. If the deactivation command is received, the process ends. Otherwise, the process returns to 1115.

When the qualifying directional input is received, the process determines (at 1125) whether that input is predominantly horizontal. That is, as described above with respect to FIG. 3, some embodiments identify the input direction based on the direction vector of the movement received through the user input device. The direction then determined at operation 1125 is the direction for which the identified direction vector has a larger component. Thus, if the direction vector has a larger horizontal component, the input is determined to be predominantly horizontal.

When the input is predominantly horizontal, the process selects (at 1130) a scrolling operation (scrolling left or scrolling right). On the other hand, when the input is predominantly vertical, the process selects (at 1135) a scaling operation (e.g., zoom in or zoom out). When the input is exactly forty-five degrees off the horizontal (that is, the vertical and horizontal components of the direction vector are equal), different embodiments default to either a scrolling operation or scaling operation.

The process next identifies (at 1140) the speed of the directional input. The speed of the directional input is, in some embodiments, the rate at which a mouse is moved across a surface, a finger moved across a trackpad or touchscreen, a stylus across a graphics tablet, etc. In some embodiments, the speed is also affected by operating system cursor settings that calibrate the rate at which a cursor moves in response to such input. The process then modifies (at 1145) the display of the navigation control according to the identified speed and direction. As illustrated in the figures above, some embodiments modify the display of the navigation control to indicate the operation being performed and the rate at which the operation being performed. That is, one of the arms of the navigation control is extended a distance based on the speed of the directional input.

The process then performs (at 1147) the selected operation at a rate based on the input speed. As mentioned above, some embodiments use the speed to determine the rate at which the scrolling or scaling operation is performed. The faster the movement, the higher the rate at which the navigation tool either scrolls the content or scales the content. Next, the process determines (at 1150) whether deactivation input is received. If so, the process ends. Otherwise, the process determines (at 1155) whether any new directional input is received. When no new input (either deactivation or new directional input) is received, the process continues to perform (at 1145) the previously selected operation based on the previous input. Otherwise, the process returns to 1125 to analyze the new input.

### III. Software Architecture

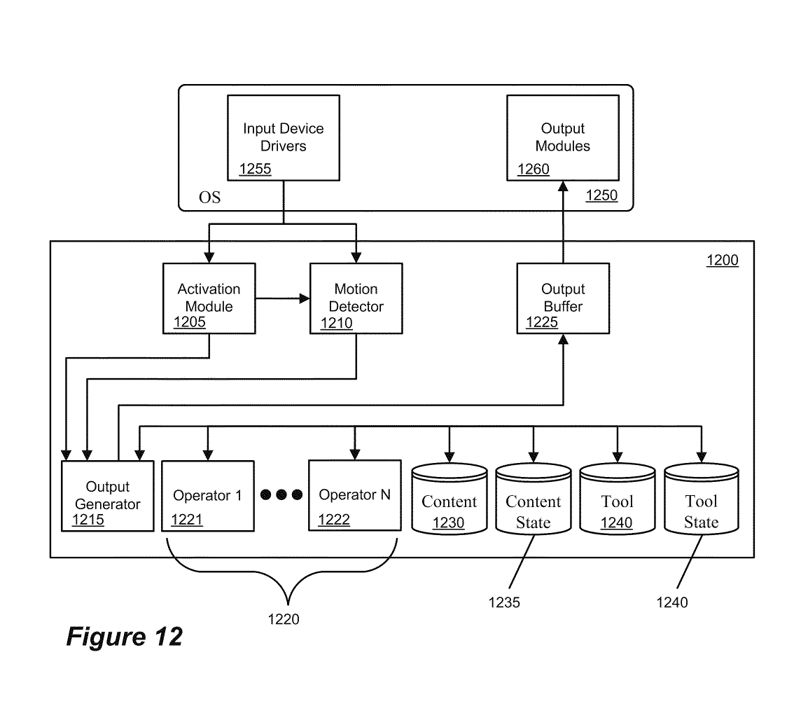

In some embodiments, the processes described above are implemented as software running on a particular machine, such as a computer or a handheld device, or stored in a computer readable medium. FIG. 12 conceptually illustrates the software architecture of an application 1200 of some embodiments for providing a multi-operation tool for performing different operations in response to user input in different directions such as those described in the preceding sections. In some embodiments, the application is a stand-alone application or is integrated into another application (for instance, application 1200 might be a part of a media-editing application), while in other embodiments the application might be implemented within an operating system. Furthermore, in some embodiments, the application is provided as part of a server-based (e.g., web-based) solution. In some such embodiments, the application is provided via a thin client. That is, the application runs on a server while a user interacts with the application via a separate client machine remote from the server (e.g., via a browser on the client machine). In other such embodiments, the application is provided via a thick client. That is, the application is distributed from the server to the client machine and runs on the client machine.

The application 1200 includes an activation module 1205, a motion detector 1210, an output generator 1215, several operators 1220, and output buffer 1225. The application also includes content data 1230, content state data 1235, tool data 1240, and tool state data 1245. In some embodiments, the content data 1230 stores the content being output—e.g., the entire timeline of a composite media presentation in a media-editing application, an entire audio recording, etc. The content state 1235 stores the present state of the content. For instance, when the content 1230 is the timeline of a composite media presentation, the content state 1235 stores the portion presently displayed in the composite display area. Tool data 1240 stores the information for displaying the multi-operation tool, and tool state 1245 stores the present display state of the tool. In some embodiments, data 1230-1245 are all stored in one physical storage. In other embodiments, the data are stored in two or more different physical storages or two or more different portions of the same physical storage. One of ordinary skill will recognize that while application 1200 can be a media-editing application as illustrated in a number of the examples above, application 1200 can also be any other application that includes a multi-operation user interface tool that performs (i) a first operation in the UI in response to user input in a first direction and (ii) a second operation in the UI in response to user input in a second direction.

FIG. 12 also illustrates an operating system 1250 that includes input device drivers 1255 (e.g., cursor controller driver(s), keyboard driver, etc.) that receive data from input devices and output modules 1260 for handling output such as display information, audio information, etc. In conjunction with or as an alternative to the input device drivers 1255, some embodiments include a touchscreen for receiving input data.

Activation module 1205 receives input data from the input device drivers 1255. When the input data matches the specified input for activating the multi-operation tool, the activation module 1205 recognizes this information and sends an indication to the output generator 1215 to activate the tool. The activation module also sends an indication to the motion detector 1210 that the multi-operation tool is activated. The activation module also recognizes deactivation input and sends this information to the motion detector 1210 and the output generator 1215.

When the tool is activated, the motion detector 1210 recognizes directional input (e.g., mouse movements) as such, and passes this information to the output generator. When the tool is not activated, the motion detector does not monitor incoming user input for directional movement.

The output generator 1215, upon receipt of activation information from the activation module 1205, draws upon tool data 1240 to generate a display of the tool for the user interface. The output generator also saves the current state of the tool as tool state data 1245. For instance, as illustrated in FIG. 2, in some embodiments the tool display changes based on the direction of user input (e.g., an arm of the tool gets longer and/or a speed indicator moves along the arm). Furthermore, the tool may be moved around the GUI, so the location of the tool is also stored in the tool state data 1245 in some embodiments.

When the output generator 1215 receives information from the motion detector 1210, it identifies the direction of the input, associates this direction with one of the operators 1220, and passes the information to the associated operator. The selected operator 1220 (e.g., operator 1 1221) performs the operation associated with the identified direction by modifying the content state 1235 (e.g., by scrolling, zooming, etc.) and modifies the tool state 1245 accordingly. The result of this operation is also passed back to the output generator 1215 so that the output generator can generate a display of the user interface and output the present content state (which is also displayed in the user interface in some embodiments).

Some embodiments might include two operators 1220 (e.g., a scrolling operator and a scaling operator). On the other hand, some embodiments might include four operators: two for each type of operation (e.g., a scroll left operator, scroll right operator, zoom in operator, and zoom out operator). Furthermore, in some embodiments, input in opposite directions will be associated with completely different types of operations. As such, there will be four different operators, each performing a different operation. Some embodiments will have more than four operators, for instance if input in a diagonal direction is associated with a different operation than either horizontal or vertical input.

The output generator 1215 sends the generated user interface display and the output information to the output buffer 1225. The output buffer can store output in advance (e.g., a particular number of successive screenshots or a particular length of audio content), and outputs this information from the application at the appropriate rate. The information is sent to the output modules 1260 (e.g., audio and display modules) of the operating system 1250.

While many of the features have been described as being performed by one module (e.g., the activation module 1205 or the output generator 1215), one of ordinary skill would recognize that the functions might be split up into multiple modules, and the performance of one feature might even require multiple modules. Similarly, features that are shown as being performed by separate modules (such as the activation module 1205 and the motion detector 1210) might be performed by one module in some embodiments.

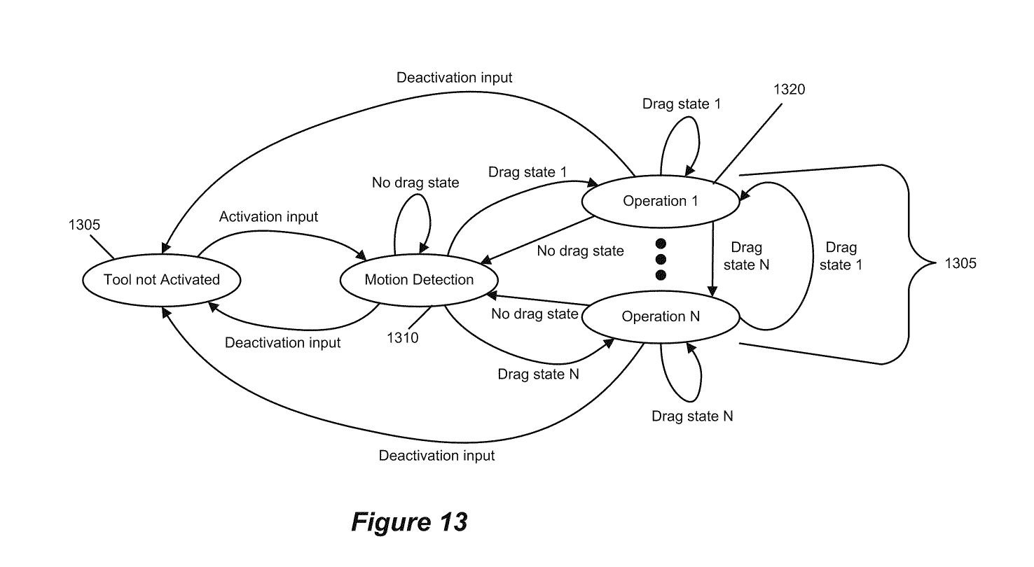

FIG. 13 illustrates a state diagram that reflects the various states and transitions between those states for a multi-operation tool such as the tool implemented by application 1200. The multi-operation tool can be a tool such as shown in FIG. 1, that navigates (by scaling operations and scrolling operations) a timeline in a media-editing application. The multi-operation tool described in FIG. 13 can also be for navigating other types of displays, or for performing other operations on other content (such as navigating and adjusting the volume of audio content, performing color correction operations on an image, etc.). The state diagram of FIG. 13 is equally applicable to cursor controller input as described in FIG. 3 and to touchscreen input as described in FIGS. 9 and 10.

As shown, the multi-operation tool is initially not activated (at 1305). In some embodiments, when the tool is not activated, a user may be performing a plethora of other user interface operations. For instance, in the case of a media-editing application, the user could be performing edits to a composite media presentation. When activation input is received (e.g., a user pressing a hotkey or set of keystrokes, a particular touchscreen input, movement of the cursor to a particular location in the GUI, etc.), the tool transitions to state 1310 and activates. In some embodiments, this includes displaying the tool (e.g., at a cursor location) in the GUI. In some embodiments, so long as the tool is not performing any of its multiple operations, the tool can be moved around in the GUI (e.g., to fix a location for a zoom operation).

So long as none of the multiple operations performed by the tool are activated, the tool stays at state 1310—activated but not performing an operation. In some embodiments, once the tool is activated, a user presses and holds a mouse button (or equivalent selector from a different cursor controller) in order to activate one the different operations. While the mouse button is held down, the user moves the mouse (or moves fingers along a touchpad, etc.) in a particular direction to activate one of the operations. For example, if the user moves the mouse (with the button held down) in a first direction, operation 1 is activated (at state 1320). If the user moves the mouse (with the button held down) in an Nth direction, operation N is activated (at state 1325).

Once a particular one of the operations 1315 is activated, the tool stays in the particular state unless input is received to transition out of the state. For instance, in some embodiments, if a user moves the mouse in a first direction with the button held down, the tool performs operation 1 until either (i) the mouse button is released or (ii) the mouse is moved in a second direction. In these embodiments, when the mouse button is released, the tool is no longer in a drag state and transitions back to the motion detection state 1310. When the mouse is moved in a new direction (not the first direction) with the mouse button still held down, the tool transitions to a new operation 1315 corresponding to the new direction.

As an example, using the illustrated examples above of a multi-operation navigation tool for navigating the timeline of a media-editing application, when the user holds a mouse button down with a tool activated and moves the mouse left or right, the scrolling operation is activated. Until the user releases the mouse button or moves the mouse up or down, the scrolling operation will be performed. When the user releases the mouse button, the tool returns to motion detection state 1310. When the user moves the mouse up or down, with the mouse button held down, a scaling operation will be performed until either the user releases the mouse button or moves the mouse left or right. If the tool is performing one of the operations 1315 and the mouse button remains held down with no movement, the tool remains in the drag state corresponding to that operation in some embodiments.

In some other embodiments, once the tool is activated and in motion detection state 1310, no mouse input (or equivalent) other than movement is necessary to activate one of the operations. When a user moves the mouse in a first direction, operation 1 is activated and performed (state 1320). When the user stops moving the mouse, the tool stops performing operation 1 and returns to state 1310. Thus, the state is determined entirely by the present direction of movement of the mouse or equivalent cursor controller.

From any of the states (motion detection state 1310 or one of the operation states 1315), when tool deactivation input is received the tool returns to not activated state 1305. The deactivation input may be the same in some embodiments as the activation input. The deactivation input can also include the movement of the displayed UI tool to a particular location in the GUI. At this point, the activation input must be received again for any of the operations to be performed.

### IV. Process for Defining an Application

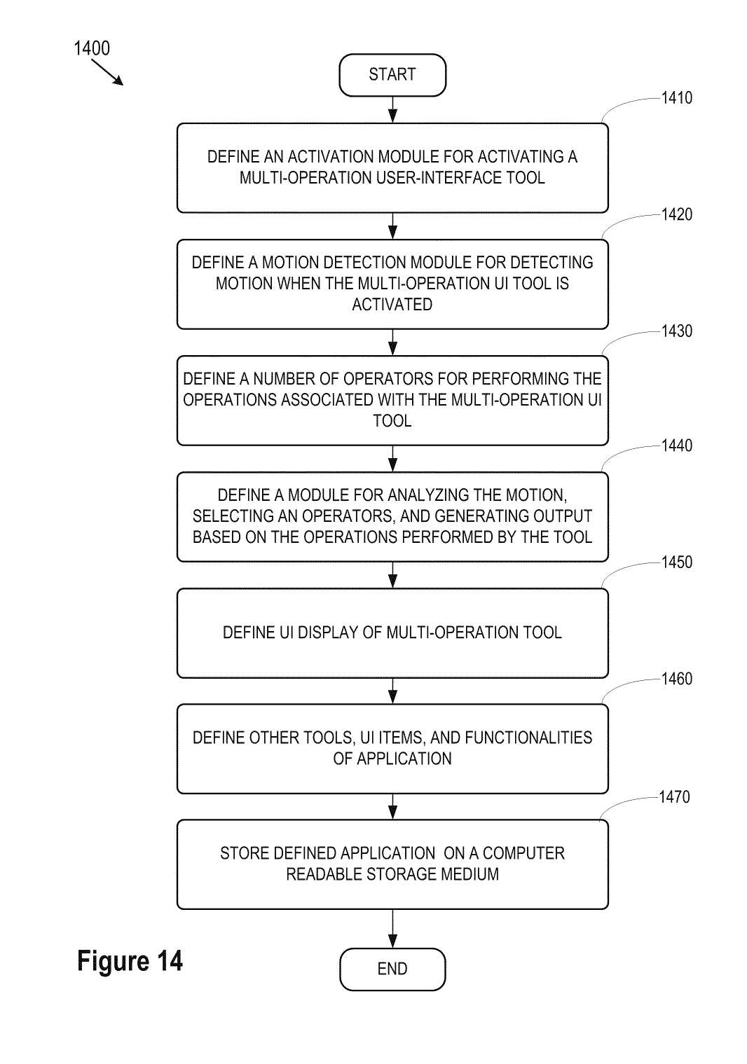

FIG. 14 conceptually illustrates a process 1400 of some embodiments for manufacturing a computer readable medium that stores an application such as the application 1200 described above. In some embodiments, the computer readable medium is a distributable CD-ROM. As shown, process 1400 begins by defining (at 1410) an activation module for activating a multi-operation user-interface tool, such as activation module 1205. The process then defines (at 1420) a motion detection module for analyzing motion from input devices when the multi-operation UI tool is activated. Motion detector 1210 is an example of such a module.

The process then defines (at 1430) a number of operators for performing the various operations associated with the multi-operation UI tool. For instance, operators 1220 are examples of these operators that perform the operations at states 1315. Next, the process defines (at 1440) a module for analyzing the motion detected by the motion detector, selecting one of the operators, and generating output based on operations performed by the operators. The output generator 1215 is an example of such a module.

The process next defines (at 1450) the UI display of the multi-operation tool for embodiments in which the tool is displayed. For instance, any of the examples shown in FIG. 4 are examples of displays for a multi-operation tool. The process then defines (at 1460) any other tools, UI items, and functionalities for the application. For instance, if the application is a media-editing application, the process defines the composite display area, how clips look in the composite display area, various editing functionalities and their corresponding UI displays, etc.

Process 1400 then stores (at 1460) the defined application (i.e., the defined modules, UI items, etc.) on a computer readable storage medium. As mentioned above, in some embodiments the computer readable storage medium is a distributable CD-ROM. In some embodiments, the medium is one or more of a solid-state device, a hard disk, a CD-ROM, or other non-volatile computer readable storage medium.

One of ordinary skill in the art will recognize that the various elements defined by process 1400 are not exhaustive of the modules, rules, processes, and UI items that could be defined and stored on a computer readable storage medium for a media editing application incorporating some embodiments of the invention. In addition, the process 1400 is a conceptual process, and the actual implementations may vary. For example, different embodiments may define the various elements in a different order, may define several elements in one operation, may decompose the definition of a single element into multiple operations, etc. In addition, the process 1400 may be implemented as several sub-processes or combined with other operations within a macro-process.

### V. Computer System

Many of the above-described features and applications are implemented as software processes that are specified as a set of instructions recorded on a computer readable storage medium (also referred to as computer readable medium). When these instructions are executed by one or more computational element(s) (such as processors or other computational elements like ASICs and FPGAs), they cause the computational element(s) to perform the actions indicated in the instructions. Computer is meant in its broadest sense, and can include any electronic device with a processor. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs when installed to operate on one or more computer systems define one or more specific machine implementations that execute and perform the operations of the software programs.

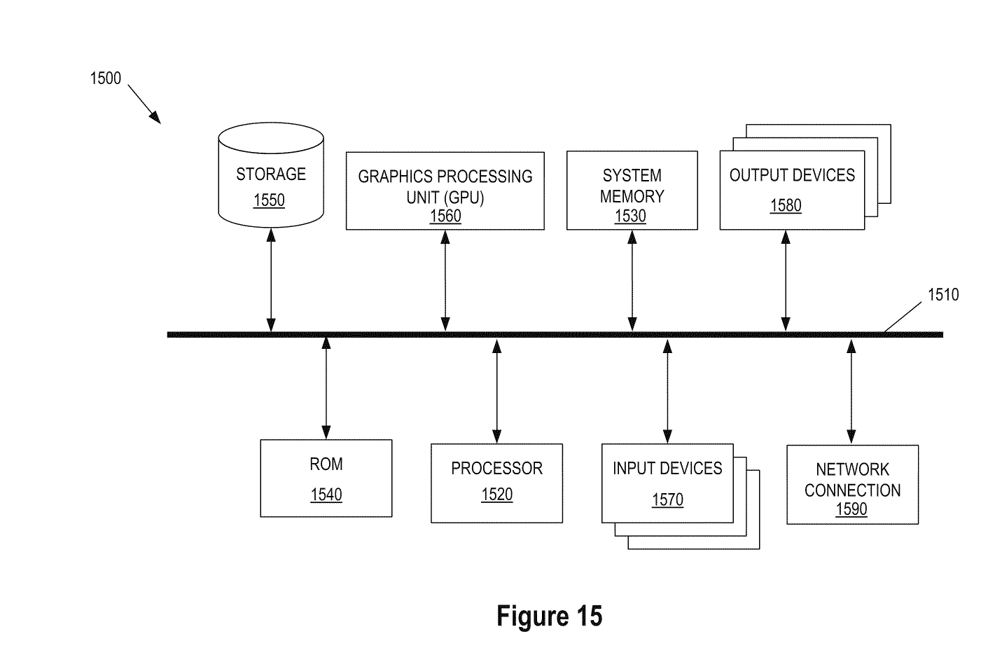

FIG. 15 illustrates a computer system with which some embodiments of the invention are implemented. Such a computer system includes various types of computer readable media and interfaces for various other types of computer readable media. Computer system 1500 includes a bus 1505, a processor 1510, a graphics processing unit (GPU) 1520, a system memory 1525, a read-only memory 1530, a permanent storage device 1535, input devices 1540, and output devices 1545.

The bus 1505 collectively represents all system, peripheral, and chipset buses that communicatively connect the numerous internal devices of the computer system 1500. For instance, the bus 1505 communicatively connects the processor 1510 with the read-only memory 1530, the GPU 1520, the system memory 1525, and the permanent storage device 1535.

From these various memory units, the processor 1510 retrieves instructions to execute and data to process in order to execute the processes of the invention. In some embodiments, the processor comprises a Field Programmable Gate Array (FPGA), an ASIC, or various other electronic components for executing instructions. Some instructions are passed to and executed by the GPU 1520. The GPU 1520 can offload various computations or complement the image processing provided by the processor 1510. In some embodiments, such functionality can be provided using Corelmage's kernel shading language.

The read-only-memory (ROM) 1530 stores static data and instructions that are needed by the processor 1510 and other modules of the computer system. The permanent storage device 1535, on the other hand, is a read-and-write memory device. This device is a non-volatile memory unit that stores instructions and data even when the computer system 1500 is off. Some embodiments of the invention use a mass-storage device (such as a magnetic or optical disk and its corresponding disk drive) as the permanent storage device 1535.

Other embodiments use a removable storage device (such as a floppy disk, flash drive, or ZIP® disk, and its corresponding disk drive) as the permanent storage device. Like the permanent storage device 1535, the system memory 1525 is a read-and-write memory device. However, unlike storage device 1535, the system memory is a volatile read-and-write memory, such a random access memory. The system memory stores some of the instructions and data that the processor needs at runtime. In some embodiments, the invention's processes are stored in the system memory 1525, the permanent storage device 1535, and/or the read-only memory 1530. For example, the various memory units include instructions for processing multimedia items in accordance with some embodiments. From these various memory units, the processor 1510 retrieves instructions to execute and data to process in order to execute the processes of some embodiments.

The bus 1505 also connects to the input and output devices 1540 and 1545. The input devices enable the user to communicate information and select commands to the computer system. The input devices 1540 include alphanumeric keyboards and pointing devices (also called “cursor control devices”). The output devices 1545 display images generated by the computer system. The output devices include printers and display devices, such as cathode ray tubes (CRT) or liquid crystal displays (LCD).

Finally, as shown in FIG. 15, bus 1505 also couples computer 1500 to a network 1565 through a network adapter (not shown). In this manner, the computer can be a part of a network of computers (such as a local area network (“LAN”), a wide area network (“WAN”), or an Intranet, or a network of networks, such as the internet. Any or all components of computer system 1500 may be used in conjunction with the invention.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable blu-ray discs, ultra density optical discs, any other optical or magnetic media, and floppy disks. The computer-readable media may store a computer program that is executable by at least one processor and includes sets of instructions for performing various operations. Examples of hardware devices configured to store and execute sets of instructions include, but are not limited to application specific integrated circuits (ASICs), field programmable gate arrays (FPGA), programmable logic devices (PLDs), ROM, and RAM devices. Examples of computer programs or computer code include machine code, such as is produced by a compiler, and files including higher-level code that are executed by a computer, an electronic component, or a microprocessor using an interpreter.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

While the invention has been described with reference to numerous specific details, one of ordinary skill in the art will recognize that the invention can be embodied in other specific forms without departing from the spirit of the invention. For example, several embodiments were described above by reference to particular media processing applications with particular features and components (e.g., particular display areas). However, one of ordinary skill will realize that other embodiments might be implemented with other types of media processing applications with other types of features and components (e.g., other types of display areas).

Moreover, while Apple Mac OS® environment and Apple Final Cut Pro® tools are used to create some of these examples, a person of ordinary skill in the art would realize that the invention may be practiced in other operating environments such as Microsoft Windows®, UNIX®, Linux, etc., and other applications such as Autodesk Maya®, and Autodesk 3D Studio Max®, etc. Alternate embodiments may be implemented by using a generic processor to implement the video processing functions instead of using a GPU. One of ordinary skill in the art would understand that the invention is not to be limited by the foregoing illustrative details, but rather is to be defined by the appended claims.

1. A computer readable medium storing a computer program for execution by at least one processor, the computer program comprising sets of instructions for:
activating a cursor to operate as a multi-operation user-interface (UI) tool;
performing a first operation with the multi-operation UI tool in response to cursor controller input in a first direction; and
performing a second operation with the multi-operation UI tool in response to cursor controller input in a second direction,
wherein at least one of the first and second operations is a non-directional operation.

2. The computer readable medium of claim 1 further comprising, prior to activating the cursor to operate as a multi-operation UI tool, receiving user input to activate the multi-operation UI tool.

3. The computer readable medium of claim 1 further comprising, prior to activating the cursor to operate as a multi-operation UI tool, identifying that the cursor is at a particular location in the user interface.

4. The computer readable medium of claim 3, wherein the cursor is activated in response to the identification that the cursor is at the particular location.

5. The computer readable medium of claim 1, wherein the first operation and second operation are navigation operations for navigating graphical content in a display area.

6. The computer readable medium of claim 5, wherein the first operation is a scrolling operation and the second operation is a scaling operation.

7. The computer readable medium of claim 1, wherein the first operation is an operation to select a number of graphical items displayed in a display area and the second operation is an operation to determine the size of the graphical items displayed in the display area.

8. The computer readable medium of claim 1, wherein the computer program is a media-editing application.

9. A method of defining a multi-operation user interface tool for a touchscreen device, the method comprising:
defining a first operation that the tool performs in response to touch input in a first direction; and
defining a second operation that the tool performs in response to touch input in a second direction,
wherein at least one of the first and second operations is a non-directional operation.

10. The method of claim 9 further comprising defining a representation of the multi-operation user interface tool for displaying on the touchscreen.

11. The method of claim 9 further comprising a third operation that the tool performs in response to touch input in a third direction.

12. The method of claim 9, wherein the touch input comprises a user moving a finger over the touchscreen in a particular direction.

13. The method of claim 9 further comprising defining a module for activating the multi-operation user interface tool in response to activation input.

14. The method of claim 13, wherein the activation input comprises touch input received through the touchscreen.

15. A computer readable medium storing a media-editing application for creating multimedia presentations, the application comprising a graphical user interface (GUI), the GUI comprising:
a composite display area for displaying graphical representations of a set of multimedia clips that are part of a composite presentation; and
a multi-operation navigation tool for navigating the composite display area, the multi-operation navigation tool for performing (i) a first type of navigation operation in response to user input in a first direction and (ii) a second type of navigation operation in response to user input in a second direction.

16. The computer readable medium of claim 15, wherein the first type of navigation operation is a scrolling operation performed in response to horizontal user input.

17. The compute readable medium of claim 16, wherein the navigation tool scrolls through the composite display area at a rate dependent on the speed of the horizontal user input.

18. The computer readable medium of claim 15, wherein the second type of navigation operation is a scaling operation performed in response to vertical user input.

19. The computer readable medium of claim 18, wherein the navigation tool scales the size of the graphical representations of multimedia clips at a rate dependent on the speed of the horizontal user input.

20. The computer readable medium of claim 15, wherein the multi-operation navigation tool only performs the navigation operations after being activated by a user.

21. The computer readable medium of claim 15, wherein the multi-operation navigation tool is for performing the first and second types of operation when a representation of the tool is displayed in a first portion of the composite display area.

22. The computer readable medium of claim 21, wherein when the representation of the tool is displayed in a second portion of the composite display area the multi-operation navigation tool is further for performing (i) a third type of navigation operation in response to user input in the first direction and (ii) a fourth type of navigation operation in response to user input in the second direction.

23. The computer readable medium of claim 22, wherein the second portion of the composite display area comprises track headers, wherein the third type of navigation operation is for scrolling through the track headers and the fourth type of navigation operation is for scaling the size of the track headers.

24. A compute readable medium storing a computer program which when executed by at least one processor navigates a composite display area of a media-editing application that displays graphical representations of media clips, the computer program comprising sets of instructions for:
receiving user input having a particular direction;
when the particular direction is predominantly horizontal, scrolling through the composite display area; and
when the particular direction is predominantly vertical, scaling the size of the graphical representations of media clips in the composite display area.

25. The method of claim 24 further comprising, prior to receiving user input having a particular direction, receiving user input to activate a multi-operation navigation tool.

26. The method of claim 25 further comprising, after receiving the user input to activate the multi-operation navigation tool, displaying a representation of the navigation tool;

27. The method of claim 24, wherein the particular direction is defined by a direction vector having vertical and horizontal components, wherein the particular direction is predominantly horizontal when the horizontal component is larger than the vertical component.

28. The method of claim 24, wherein the particular direction is defined by a direction vector having vertical and horizontal components, wherein the particular direction is predominantly vertical when the vertical component is larger than the horizontal component.
